(19) United States
(12) Patent Application Publication
(10) Pub. No.: US 2026/0023930 A1
(43) Pub. Date: Jan. 22, 2026

(54) SYSTEM AND METHOD OF ARTIFICIAL INTELLIGENCE PRODUCTIVITY TOOL ORCHESTRATING PERFORMANCE OF USER-REQUESTED AI PRODUCTIVITY TOOL ENABLEABLE SOFTWARE APPLICATION CAPABILITIES

(71) Applicant: Dell Products LP, Round Rock, TX (US)

(72) Inventors: Jacob Mink, Cedar Park, TX (US); Srikanth Kondapi, Austin, TX (US); Chih-Chien Hsiao, Taipei City (TW)

(73) Assignee: Dell Products LP, Round Rock, TX (US)

(21) Appl. No.: 18/778,943

(22) Filed: Jul. 20, 2024

(51) Int. Cl. G06F 40/30

(52) U.S. Cl. CPC G06F 40/30

(57) ABSTRACT

An information handling system operating an On the Box (OTB) Artificial Intelligence (AI) productivity tool may comprise a hardware processor to execute machine readable code instructions of an AI productivity tool enableable software application to register with the OTB AI productivity tool a dynamically updated capability for an AI productivity tool enableable software application having a natural language description. The hardware processor may execute machine readable code instructions of the OTB AI productivity tool to generate a vectorized capability intent value from the updated capability natural language description, to receive a user query input requesting performance of an action, to determine that a vectorized query input intent value for the user query input correlates to the vectorized capability intent value, indicating that the user query input is requesting performance of the updated capability, and to instruct the AI productivity tool enableable software application to perform the updated capability.

### FIELD OF THE DISCLOSURE

The present disclosure generally relates to an on the box (OTB) artificial intelligence (AI) productivity tool that employs machine learning models stored at an information handling system for optimizing user productivity and information handling system performance. The present disclosure more specifically relates to an application programming interface (API)-agnostic method for such execution of machine readable code instructions for an OTB AI productivity tool to determine a vectorized user query input intent value for a user query input received via a universal software application conversational interface software application, identify a pre-registered capability for an AI productivity tool enableable software application having a correlating capability intent value, and instruct the AI productivity tool enableable software application to invoke an API call corresponding to the identified pre-registered capability.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more artificial intelligence (AI) productivity tool enableable software applications, chat bots, or the like. Further, the information handling system may include an on the box (OTB) artificial intelligence (AI) productivity tool employing machine learning models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system executing machine readable code instructions for an on the box (OTB) artificial intelligence (AI) productivity tool for optimizing user experience and performance of AI productivity tool enableable software applications and hardware components at the information handling system according to an embodiment of the present disclosure;

FIG. 2 is a block diagram illustrating a hardware processor executing machine readable code instructions for an OTB AI productivity tool to instruct an AI productivity tool enableable software application to invoke an API call corresponding to a pre-registered capability having a vectorized capability intent value from natural language processing (NLP) correlating to a vectorized query input intent value for a received user query input according to an embodiment of the present disclosure;

FIG. 3 is a swim lane flow diagram illustrating a process for a hardware processor executing machine readable code instructions of an OTB AI productivity tool to instruct an AI productivity tool enableable software application to perform a pre-registered capability having a vectorized capability intent value from NLP correlating to a vectorized query input intent value for a received user query input according to an embodiment of the present disclosure; and

FIG. 4 is a flow diagram illustrating an API-agnostic method of a hardware processor executing machine readable code instructions to instruct execution of a pre-registered capability having an NLP-descriptive vectorized capability intent value by an AI productivity tool enableable software application, in response to a user query input according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems, including computers, mobile computers, and smart phones are increasingly employing artificial intelligence (AI) productivity tools to optimize user productivity and performance of the information handling systems. Examples of such artificial intelligence methodologies includes chatbots to simulate conversations between the information handling system and the user. In an example embodiment of the present disclosure, an AI productivity tool may be used to trigger changes in firmware (e.g., changing display or power settings), software, or processes of one or more AI productivity tool enableable software applications (e.g., send an e-mail or text message, schedule a meeting). Various machine learning models may be used to support such functionality, including automatic speech recognition (ASR) models, text embedding models, and similarity search models that may work in combination with one another to identify an action that may be taken by an AI productivity tool enableable software application as requested within a received user query input according to embodiments herein. For example, an existing AI productivity tool may be capable of determining a user's intent for correlation to an action the user is requesting to be performed within a user query input, and matching that determined query intent with a capability intent known to be achievable, based on published or established capabilities by a particular AI productivity tool enableable software application executing at the information handling system. In some AI productivity tools, once the AI productivity tool enableable software application capable of performing the user-requested action within the user query input is identified, the AI productivity tools may identify an application programming interface (API) call that, when executed, may cause the AI productivity tool enableable software application associated with the identified capability to perform that capability.

Prior to such a process and prior to a user providing such a user query input into an AI productivity tool, each of a plurality of AI productivity tool enableable software applications, have an application programming interface (API) and may register with the existing AI productivity tool a list of capabilities achievable by that AI productivity tool enableable software application. In some embodiments, that list of capabilities includes a list or library of API calls associated with each of those capabilities that the AI productivity tools can use to cause the AI productivity tool enableable software applications to execute such capabilities. Such a registration of capabilities at an AI productivity tool, especially those that involve adjusting functionality of hardware components at the information handling system may not take into account current configurations and policies of those hardware components or current versions of AI productivity tool enableable software applications, which may disallow or make perfunctory such capabilities. For example, an AI productivity tool enableable software application may have a registered capability for optimizing battery performance, but such an AI productivity tool enableable software application may not be capable of performing that capability at a time when the battery or other hardware component has been removed from or altered within the information handling system or a version of the AI productivity tool enableable software application may have recently added. Thus, each time such a hardware component configuration changes or a version of the AI productivity tool available software application is changed, the actual list of capabilities performable by the AI productivity tool enableable software application may change. However, this may not be reflected by the registered list of capabilities for the AI productivity tool enableable software application in the AI productivity tool. Further, each time an AI productivity tool enableable software application is internally updated, the AI productivity tool enableable software application would be required to re-register the list of API calls with the existing AI productivity tools. This would further cause a need to update the AI productivity tool or modules of the AI productivity tool repeatedly. Because the existing AI productivity tools may orchestrate functionality of a plurality of AI productivity tool enableable software applications, this may result in high-overhead associated with a high frequency of API call updates being registered and, consequently, high frequency of updates to the AI productivity tools. A system is needed that negates the need for these AI productivity tool enableable software applications to re-register such API calls, thus negating the need to update the AI productivity tool as frequently, decreasing overhead at the AI productivity tool, and updating the registered capability list to those actually achievable in accordance with current hardware component configurations and policies or a with updates to the version of the AI productivity tool enableable software application.

A hardware processor for an information handling system executing machine readable code instructions for an on the box (OTB) AI productivity tool in embodiments herein may address these issues by circumventing registration of API calls and only instructing performance of capabilities for an AI enableable software application that are in accordance with current hardware component configurations and policies based on natural language processing (NLP) of capabilities of the AI productivity tool enableable software application. In embodiments herein, a manufacturer of edge devices, such as personal or enterprise laptops may develop and install on individual edge device information handling systems an OTB AI productivity tool that employs locally executed machine learning models to optimize user productivity and performance of the information handling system using artificial intelligence methodologies. The OTB AI productivity tool in embodiments herein may receive a user query input requesting that an action be taken at the information handling system, and may use machine-learning methodologies to identify a pre-registered capability having an NLP processed capability intent value for an AI productivity tool enableable software application that may perform the requested action. For example, a user query input to “make my system faster” may be associated with a natural language defined capability of an AI productivity tool enableable software application to “decrease usage of the central processing unit (CPU) by background applications.” As another example, a user query input to “make my image clearer” may be associated with a natural language defined capability of an AI productivity tool enableable software application to “improve the image resolution at the display device.” In yet another example, a user query input requesting that the information handling system “extend battery life” may with a natural language defined capability of an AI productivity tool enableable software application to “decrease battery usage,” or to “maximize battery charging.”

In embodiments herein, rather than identifying an API call for an AI productivity tool enableable software application for executing the determined capability, a hardware processor executing machine readable code instructions of the OTB AI productivity tool may instruct the AI productivity tool enable software application that pre-registered the determined capability having an NLP defined description of the capability and associated with the API call is used instead to perform that specific capability. This may shift the responsibility for identifying an updated API call for executing that capability to the AI productivity tool enableable software application, and away from the OTB AI productivity tool, in that the NLP is used for capability descriptions such that APIs need not be defined in the AI productivity tool directly. This may further negate the need for the AI productivity tool enableable software applications to register and update the list of API calls for each of their pre-registered capabilities with the AI productivity tool when versions change, negating frequent updates to the OTB AI productivity tool itself with each API call update, and lowering overhead. In such a way, the OTB AI productivity tool may use an API-agnostic method of directing an AI productivity tool enableable software application to perform a user-requested action within a corresponding user query input.

Further, a hardware processor executing machine readable code instructions for each of the AI productivity tool enableable software applications executing at the information handling system may routinely check current configurations, policies, and statuses of hardware components at the information handling system and limit or adjust the registered list of capabilities having NLP defined capability intent values for the capability descriptions for those AI productivity tool enableable software applications to those invoking actions on the part that are in accordance with the current hardware configurations and policies. For example, an AI productivity tool enableable software application that is generally capable of optimizing battery performance may have a first list of capabilities having NLP defined capability intent values for the capability descriptions that includes “minimize battery usage,” or “optimize battery charging.” During a routine check of current configurations for a power management unit that incorporates a removable battery, a hardware processor may execute machine readable code instructions for the AI productivity tool enableable software application that registered these capabilities having NLP defined capability intent values for the capability descriptions to determine that the battery has been removed. In such a scenario, the hardware processor executing machine readable code instructions for this AI productivity tool enableable software application may then register an updated list of capabilities having NLP defined capability intent values for the capability descriptions that omits the capabilities to “minimize battery usage,” or to “optimize battery charging,” since no action may be taken on the removed battery by the AI productivity tool enableable software application. By tailoring the registered list of capabilities having NLP defined capability intent values for the capability descriptions in such a way, the hardware processor executing machine readable code instructions for the AI productivity tool enableable software application and the OTB AI productivity tool may ensure that any commands to alter functionality of a hardware component operating on the information handling system are in accordance with current hardware configuration and policies.

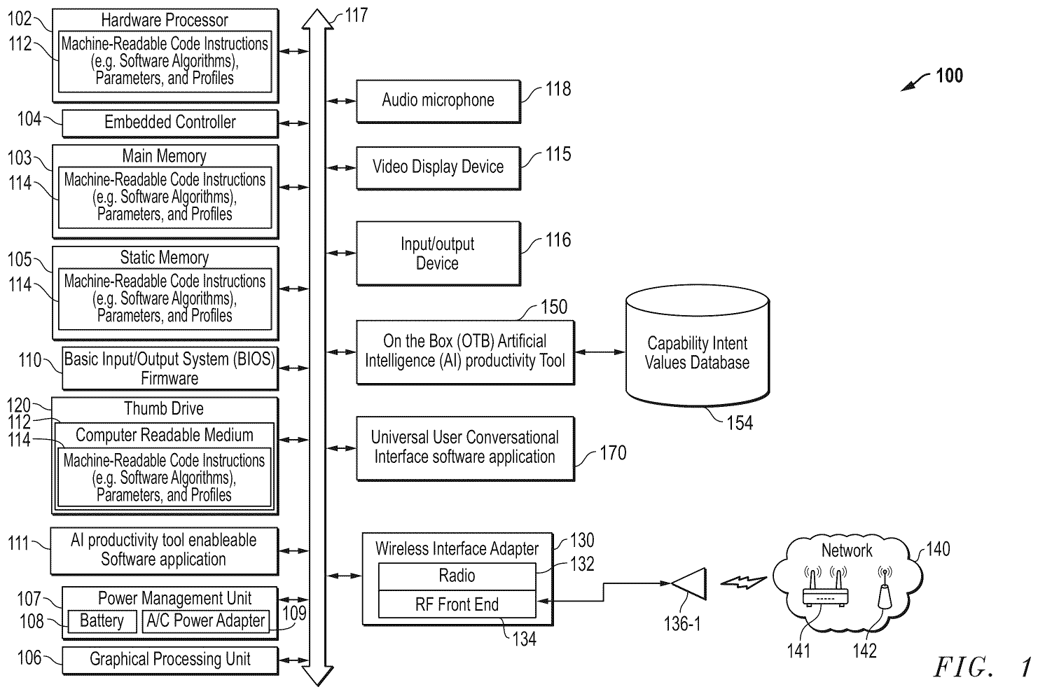

Turning now to the figures, FIG. 1 illustrates an information handling system 100 similar to the information handling systems according to several aspects of the present disclosure. As described herein, an on the box (OTB) artificial intelligence (AI) productivity tool 150 in an embodiment, which may orchestrate functionality of a plurality of local AI productivity tool enableable software applications 111 at an information handling system 100. The OTB AI productivity tool 150 may circumvent high-overhead registration of API calls by each of such AI productivity tool enableable software applications 111 by using natural language processing (NLP) defined descriptions of the capability intent associated with a capability intent name and identification (ID) such that the OTB AI productivity tool 150 generates semantic embeddings of the capability intent values based on the NLP-defined descriptions in embodiments herein. Further the OTB AI productivity tool 150 may also be limited or adjusted to only instruct performance of actions by the AI productivity tool enableable software application 111 that are in accordance with current configurations and policies for hardware components (e.g., 102, 103, 104, 105, 106, 107, 115, 116, 118, and 130) operating at the information handling system 100 in other embodiments. In an embodiment, a manufacturer of edge devices, such as personal or enterprise laptops (e.g., information handling system 100) may develop and install on individual edge device information handling systems (e.g., 100) an OTB AI productivity tool 150 that employs locally executed machine learning models to optimize user productivity and performance of the information handling system 100 using artificial intelligence methodologies.

The OTB AI productivity tool 150 in an embodiment may receive, via a universal user conversational interface software application 170, a user query input requesting that an action be taken at the information handling system 100. Such a universal user conversational interface software application 170 may operate separate and apart from the AI productivity tool enableable software application 111 or in connection with the same, and may service user query requests for actions to be taken by any number of a plurality of AI productivity tool enableable software applications 111. The OTB AI productivity tool 150 may operate to identify which of the plurality of AI productivity tool enableable software applications, including 111 may be capable of performing the action requested by the user within the user query input. Such a user query input may be made in voice format via the microphone 118, or in text format, for example, via the input/output device 116 such as a keyboard.

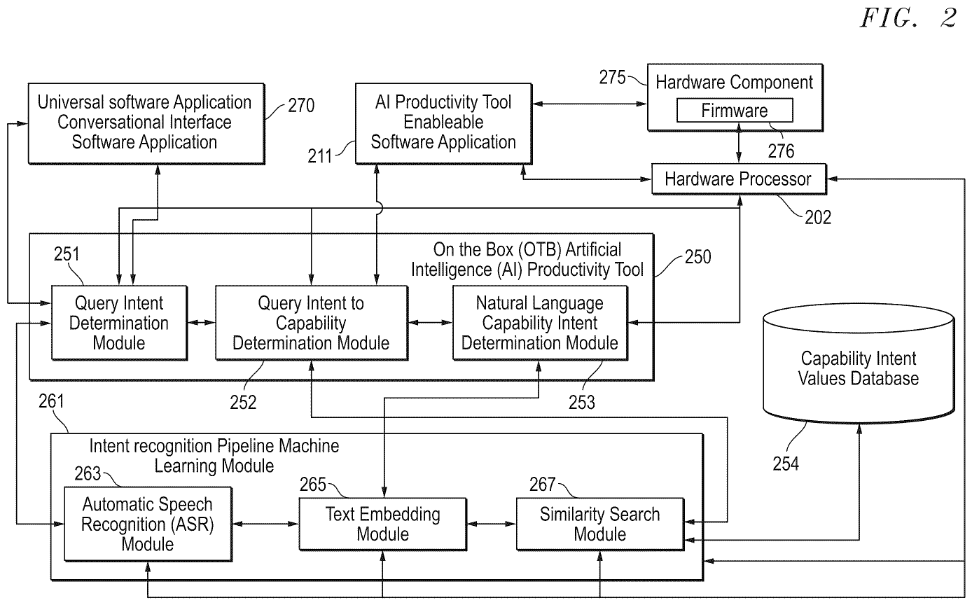

As described in greater detail below with respect to FIG. 2, a hardware processor 102 executing machine readable code instructions of the OTB AI productivity tool 150 may use an API-agnostic method of directing an AI productivity tool enableable software application to perform a user-requested action within a user query input. For example, the hardware processor 102 in an embodiment may execute machine-readable code instructions of the OTB AI productivity tool 150 to determine a vectorized query input intent value for the received user query input, and to identify a capability that has been pre-registered by the AI productivity tool enableable software application 111 having a vectorized capability intent value that correlates to the determined vectorized query input intent value. This may indicate that the request made in natural language within the user query input is requesting that the AI productivity tool enableable software application 111 perform the pre-registered capability.

The capability intent values are a mathematical representation of the natural language descriptions of capability operations or services from various AI productivity tool-enablable software applications 111 in an embodiment, as generated using natural language processing (NLP) techniques. These capability intent values may be represented by a mathematical value in a multi-axis vector space that may be associated with the natural language description for that capability or intent for an embedded meaning value applied to the capability natural language description. In an embodiment, the capabilities may also be associated with an identification (ID) such as an alphanumeric ID that may be stored within a capability intent values database 154. These capabilities stored at the capability intent values database 154 may include any input and output capabilities provided by the AI productivity tool-enablable software applications 111 being executed by the hardware processor 102 or any other hardware processing devices (e.g., 104 or 106). For example, an AI productivity tool-enablable software application 111 may include a word processing application such as Microsoft® Word® that may receive input (e.g., via voice at a microphone 118 or text via a keyboard 116) and provide output via text. Still further, other examples of an AI productivity tool-enablable software application 111 may include an updating software, virus protection software, and setting optimization software such as Dell® SupportAssist® module executable by the hardware processor or other hardware processing resource of the information handling system. With SupportAssist® a user may provide input via, for example, the microphone 118 requesting information related to a setting associated with the information handling system. Thus, capabilities of SupportAssist® may include virus protection capabilities, setting manipulation capabilities, and software updating capabilities that may each be stored at the capability intent values database 154.

Even further, examples of an AI productivity tool-enablable software application 111 may include Dell® Display®/Peripheral Manager®. The Dell® Display®/Peripheral Manager® may have capabilities that include optimization of screen resolution, refresh rates, and gamma correction as well as webcam settings, mouse settings, keyboard settings, stylus settings, microphone settings, and trackpad settings, among other settings and connections associated with the wired or wireless input/output devices. Again, these capabilities associated with the execution of the Dell® Display®/Peripheral Manager® software may have capability intent values derived from natural language descriptors of each of those capabilities and a capability identifier stored at the capability intent values database 154 as described herein. It is appreciated that the AI productivity tool-enablable software application 111 may include, for example, Dell® Trusted Device® software, a remediation Dell® APEX Managed Device Service (AMDS)® software, Alienware Command Center (AWCC)® software, among others. Some AI productivity tool-enablable software applications 111 may even be subagents operating locally on the box of the information handling system but have remote access to a larger software application executing at a cloud based server location for providing software services in some embodiments herein. These “capabilities” may be registered with the OTB AI productivity tool 150 in an embodiment for establishing capability intent values for these capabilities such that chat user query input intent values may be correlated with one or more capability intent values for the natural language descriptions of registered capabilities, as described herein. For example, in an embodiment in which the AI productivity tool enableable software application 111 is software application for optimizing performance of hardware components at the information handling system, such capabilities may include adjusting settings or configurations for various hardware components. Such capabilities may include natural language descriptor terms or phrases including “adjust,” “configuration”, as well as terms for the hardware components or setting or configuration that is adjustable by the capability. As another example, in an embodiment in which the AI productivity tool enableable software application 111 optimizes performance of other software applications, such capabilities may include automatically downloading and installing updates for such AI productivity tool enableable software applications 111. Again, the capabilities may include natural language descriptions as well for “update,” “install,” “optimize,” as well as names of software or firmware to be updated or other descriptors. In yet another example, in an embodiment in which the AI productivity tool enableable software application 111 is one of several software applications routinely executing on the information handling system, and optimized by such an OTB AI productivity tool 150, such capabilities may include automatically generating and transmitting e-mails or text messages, automatically scheduling meetings, or generating chatbot or other user interface responses. These and any registrable capabilities will also include similar natural language descriptions. These “capabilities” may be registered, associated with a specific AI productivity tool enableable software application 111, and stored with capability name, capability ID, natural language descriptor, capability intent value, or other data at the capability intent values database 154 in an embodiment.

These input and output capabilities provided by the AI productivity tool-enableable software applications 111 in an embodiment may be triggered for execution by an API call specific to the AI productivity tool-enableable software application 111. Further, these input and output capabilities may be updated to include new input and output capabilities of the AI productivity tool enableable software application 111, or to remove previously existing input and output capabilities, as the AI productivity tool enable software application 111 undergoes various updates. For example, an updated version of an AI productivity tool-enablable software application 111 for updating software, virus protection software, and setting optimization, such as Dell® SupportAssist® module may add a capability to optimize battery charging or test for a newly developed and recognized computer virus, such as “Virus X.” In such an embodiment, the hardware processor 102 executing machine readable code instructions for the AI productivity tool enableable software application 111 may update the stored capability intent values database to add new natural language descriptions such as “optimize my battery charging,” or “scan for Virus X.” Each of these newly added natural language descriptions of capabilities may then be assigned a capability ID and capability name by the AI productivity tool enableable software application 111.

Any such updates to the input and output capabilities of the AI productivity tool enableable software application could require a corresponding update to a library of API calls for the AI productivity tool enableable software application 111 accessible by the OTB AI productivity tool 150. However, embodiments of the present disclosure circumvent this step of updating API calls by executing machine readable code instructions of the AI productivity tool enableable software application 111 to dynamically adjust the stored database of natural language descriptions for input and output capabilities at the capability intent values database 154 for the AI productivity tool enableable software application 111. Then natural language processing and capability intent value embedding may be used to dynamically determine capability intent values for each of the capability natural language descriptions in the registered list of capabilities before use in correlating with query intent values. Changes made to the capability intent values database 154 in such a way may not require any update to the OTB AI productivity tool 150 itself. Thus, embodiments of the present disclosure allow for updates being made to the capabilities of the AI productivity tool enableable software application 111, as recognized and invokable by the OTB AI productivity tool 150 that do not require any update to the OTB AI productivity tool 150 itself.

Each of the capabilities stored at the capability intent values database 154, and updated by the AI productivity tool enableable software application 111 may have a description with text descriptors, may be associated with a unique ID, and may have a capability intent value generated from those updates in an embodiment. Upon registration or updating of a given capability by the AI productivity tool enableable software application 111 in an embodiment, a hardware processor 102 for the information handling system may execute machine readable code instructions for one or more text embedding algorithms to generate a multi-dimensional vector capability intent value for that capability that, for example, may be based on text descriptors for that capability. Each of these capability intent values for association with these initial or recently updated capabilities may also be associated with an ID such as an alphanumeric ID that may identify, uniquely, these capabilities in the capability intent values database 154, for example, in a dynamically updated registered capabilities list. These capability intent values may later be used to determine which of the initial or recently updated capabilities a user intends to invoke or execute within a received user query input based on similarity with a query intent value, as described herein.

As described above, the capability intent values dynamically generated for natural language descriptions of initial or updated capabilities for an AI productivity tool enableable software application are a vectorized mathematical representation in a multi-axis vector space of the natural language descriptions of capability operations or services from various AI productivity tool-enablable software applications 111 in an embodiment, as generated using natural language processing (NLP) techniques. Each axis of the multi-axis vector space may provide a measurement of various attributes of a text excerpt that are known to provide context or semantic understanding of the text. For example, some axis values may represent a reader's understanding of a given text excerpt that would depend upon the reader's knowledge of any given word's meaning within the text, identified phrases within the text, or the understood order or sequence of words within the text. More specifically, an axis value of a generated capability intent value may represent a reader's understanding as enhanced by the reader having a larger vocabulary and understanding of which words in that vocabulary are synonyms (closer in meaning) to a given word in that text, and which words are antonyms (further away in meaning) to that given word. As another example, values along an axis of the capability intent values may represent the reader's ability to identify common phrases, such as “in other words” may provide greater insight to the semantic meaning of a text excerpt using this phrase than the reader's understanding of each of the words “in,” “other,” and “words” used separately from one another. As yet another example, values along an axis of the capability intent values may represent the importance of the order of certain words in an excerpt may impact semantic meaning of the excerpt. More specifically, the phrase “man bites dog” may have a completely different semantic or contextual meaning than the phrase “dog bites man,” although each phrase has the same words, just in a different order.

Each axis of the multi-axis vector space, and thus, each value within a vector within such a multi-axis vector space may provide a measurement of these various attributes within a given initial or updated capability intent value upon dynamic generation for an available capabilities list in embodiments herein. For example, a vector for a user query input intent value or for capability intent value may provide a measurement of similarity between any given word within the user query input or AI productivity tool enablable software application capabilities, respectively, a measurement of dissimilarity with known antonyms, identification of any given word as part of a phrase, or usage of any given word in a specific order that is known to be of importance. In such a way, the vectorized user query input intent value and capability intent values may mathematically represent a reader's contextual or semantic understanding of the user query input and the natural language descriptors for the capabilities of the AI productivity tool enableable software applications. These vectors may then be compared to one another in order to understand how alike various phrases within the user query input and capabilities are, and how alike the usage of those words and phrases are to provide a context, such as influenced by the order of those words or phrases and their relation to one another.

Upon making such a match, the OTB AI productivity tool 150 may transmit an instruction to the AI productivity tool enableable software application 111 to perform the pre-registered capability by identifying the capability ID associated with the vectorized capability intent value that best matches the vectorized user query input intent value. The AI productivity tool enableable software application 111 in an embodiment may then identify an API call to invoke in order to perform the pre-registered capability, which may address the request given within the user query input. The association between the registered capability and the appropriate API call for performing such a capability may be among current capabilities maintained and known to the AI productivity tool enableable software application 111 invoking the API call, but not necessarily by the OTB AI productivity tool 150. Thus, any updates to the AI productivity tool enableable software application 111 that affect the library of API calls but do not affect basic functionality of the AI productivity tool enableable software application 111 as described in the registered natural language capabilities need not be re-registered with the OTB AI productivity tool 150, and the OTB AI productivity tool 150 need not be updated to reflect the changed library of API calls.

Further, a hardware processor 102 executing machine readable code instructions for each of the AI productivity tool enableable software applications 111 at the information handling system 100 may routinely check current configurations, policies, and statuses of hardware components (e.g., 102, 103, 104, 105, 106, 107, 115, 116, 118, and 130) at the information handling system 100, as well as software changes, and dynamically adjust the capabilities registered at the OTB AI productivity tool 150, via a natural language description of those capabilities with each change, to those invoking actions on the part of the AI productivity tool enableable software application 111 that are in accordance with the current hardware configurations and policies. For example, an AI productivity tool enableable software application 111 that is generally capable of optimizing performance of the removeable battery 108 may have a first list of capabilities stored in the capability intent values database 154 that includes the natural language descriptions “minimize battery usage,” or “optimize battery charging.” Each of these natural language descriptions in an embodiment may also be associated with a capability ID (e.g., alphanumeric identification) and capability name.

In a specific example embodiment, during a routine check of current configurations for a power management unit 107 that incorporates the removable battery 108, the hardware processor 102 executing machine readable code instructions for the AI productivity tool enableable software application 111 that previously registered these existing capabilities may determine that the battery 108 has been removed or replaced and that the AI productivity tool enableable software application 111 has been updated to reflect this change. In such a scenario, the hardware processor 102 executing machine readable code instructions for this AI productivity tool enableable software application 111 may dynamically register an updated list of capabilities that omits or adds the natural language descriptions “minimize battery usage,” or to “optimize battery charging,” as well as the capability ID and capability names associated with those omitted natural language descriptions, depending on whether action may be taken on the battery 108 by the AI productivity tool enableable software application 111 pending detection of it being removed or installed.

As another example, an AI productivity tool enableable software application 111 that is generally capable of directing operation of the wireless interface adapter 130 may have a first list of capabilities that includes “use a cellular signal,” or “switch to Wi-Fi.” During a routine check of current configurations for the wireless interface adapter 130 that incorporates a WWAN (e.g., cellular) antenna 136-1, the hardware processor 102 executing machine readable code instructions for the AI productivity tool enableable software application 111 that previously registered these existing capabilities may determine that the WWAN antenna 136-1 is currently offline. In such a scenario, the hardware processor 102 executing machine readable code instructions for this AI productivity tool enableable software application 111 may register an updated list of capabilities that omits “use a cellular signal” since the hardware component 136-1 capable of performing this action is offline.

As another example, an AI productivity tool enableable software application 111 that is generally capable of directing operation of the wireless interface adapter 130 may have a first list of capabilities that includes “use or connect with a Wi-Fi signal,” but adds cellular capability such as a newly added cellular subscription made available. A new capability may be added for “switch to a cellular signal” or “switch to Wi-Fi” to be able to switch between available wireless networks. During a routine check of current configurations for the wireless interface adapter 130 that incorporates a WWAN (e.g., cellular) antenna 136-1, the hardware processor 102 executing machine readable code instructions for the AI productivity tool enableable software application 111 that previously registered these existing capabilities may determine that the WWAN antenna 136-1 new available. In such a scenario, the hardware processor 102 executing machine readable code instructions for this AI productivity tool enableable software application 111 may register an updated list of capabilities that includes new natural language descriptors for “switch to a cellular signal” and “switch to Wi-Fi” since the hardware component 136-1 capable of performing this action now with the AI productivity tool enableable software application 111.

In yet another example, an AI productivity tool enableable software application 111 that is generally capable of directing operation of the digital display 115 may have a first list of capabilities adjustment of digital display parameters but did not have available changes to display resolution of high-definition resolution. During a routine check of current configurations for the digital display 115, the hardware processor 102 executing machine readable code instructions for the AI productivity tool enableable software application 111 that previously registered these existing capabilities may determine that the digital display 115 is swapped out or updated to include higher resolution options or capable of high-definition (HD) display resolution. In such a scenario, the hardware processor 102 executing machine readable code instructions for this AI productivity tool enableable software application 111 may register an updated list of capabilities that adds natural language descriptions of “increase display resolution” or “display images in HD,” since the display device 115 is not capable of displaying images in HD.

In still another example, an AI productivity tool enableable software application 111 may have a first list of capabilities, such as “save data to removeable memory device” that include actions that may be barred by administrator-imposed hardware configuration policies. During a routine check of current configurations and policies for drive unit 120, the hardware processor 102 executing machine readable code instructions for the AI productivity tool enableable software application 111 that previously registered these existing capabilities may determine that an administrator for the information handling system 100 has restricted storage of data to local and permanent storage in main memory 102 or static memory 103, and bars storage of data to removeable drive 120. In such a scenario, the hardware processor 102 executing machine readable code instructions for this AI productivity tool enableable software application 111 may register an updated list of capabilities that omits “save data to removeable memory device,” since the current policies do not allow this action.

As yet another example, an AI productivity tool enableable software application 111 may have a first list of capabilities, such as “connect to network with best received signal strength indicator (RSSI)” that include actions that may be added or barred by administrator-imposed hardware configuration policies. During a routine check of current configurations and policies for wireless interface adapter 130, the hardware processor 102 executing machine readable code instructions for the AI productivity tool enableable software application 111 that previously registered this existing capability may determine that an administrator for the information handling system 100 has added or restricted wireless connectivity to specifically identified secure networks, or added or limited connectivity to networks that are costly due to subscription. In such an example embodiment, the hardware processor 102 executing machine readable code instructions for this AI productivity tool enableable software application 111 may register an updated list of capabilities that amends “connection to network with best RSSI,” since the network with the best RSSI may not be on the list of allowable, secure networks or may be superseded by a requirement to use lower cost networks first. An additional capability may be added such as “connection to free network” or “connection to network with lowest cost.” By tailoring the registered list of capabilities in such a way, the hardware processor 102 executing machine readable code instructions for the AI productivity tool enableable software application 111 and the OTB AI productivity tool 150 may ensure that any commands to alter functionality of a hardware component operating on the information handling system are in accordance with current hardware configuration and policies.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, other hardware controllers, or any combination thereof. Additional components of the information handling system 100 may include one or more storage devices such as static memory 105 or drive unit 120. The information handling system 100 may include or interface with one or more communications ports for communicating with external devices, as well as an input/output (IO) device 116, a video/graphics display device 115, an audio microphone 118 for recording user communications, or any combination thereof. Portions of an information handling system 100 may themselves be considered information handling systems 100.

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 may operate on a plurality of information handling systems 100. In a specific embodiment, machine readable code instructions for the OTB AI productivity tool 150, a universal user conversational interface software application software application 170, and one or more AI productivity tool enableable software applications 111 may execute locally at the information handling system 100, or on the box.

The information handling system 100 may include the hardware processor 102 such as a central processing unit (CPU) or other hardware processing resources. Any of the hardware processing resources may operate to execute machine readable code instructions 114 that are either firmware or software code. Moreover, the information handling system 100 may include memory such as main memory 103, static memory 105, and disk drive unit 120 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, EC 104, GPU 106, or any other hardware processing device. The information handling system 100 may also include one or more buses 117 operable to transmit communications between the various hardware components such as any combination of various I/O devices 116 as well as between hardware processors 102, an EC 104, GPU 106 or other, the operating system (OS) 111, the basic input/output system (BIOS) 110, the wireless interface adapter 130, or a radio module 132, among other components described herein. In an embodiment, the hardware processor 102, EC 104, and/or GPU 106 may execute one or more bus drivers in order to transmit this data between the information handling system 100 and the input/output devices 116 described herein. As described herein, the information handling system 100 further includes a video/graphics display device 115. The video/graphics display device 115 in an embodiment may function as a liquid crystal display (LCD), an organic light emitting diode (OLED), a flat panel display, or a solid-state display. It is appreciated that the video/graphics display device 115 may be wired or wireless and may be an external video/graphics display device 115 that allows a user to increase the desktop area by extending the desktop in an embodiment.

A network interface device of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system 100 to a network 140 via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Wireless interface adapter 130 may include one or more RF (RF) subsystems (e.g., radio 132) with transmitter/receiver circuitry, modem circuitry, one or more antenna RF (RF) front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6c, and the emerging Wi-Fi 7 standard. It is understood that any number of available channels may be available in WLAN under the 2.4 GHZ, 5 GHz, or 6 GHz bands which may be shared communication frequency bands with WWAN protocols or Bluetooth® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130.

The information handling system 100 may include a set of instructions 114 that may be executed to cause the computer system to perform any one or more of the methods or computer-based functions disclosed herein. For example, machine readable code instructions 114 may be executed by a hardware processor 102, GPU 106, EC 104 or any other hardware processing resource and may include software agents, or other aspects or components used to execute the methods and systems described herein. Various software modules comprising application machine readable code instructions 114 may be coordinated by an OS 111, and/or via an application programming interface (API) include a unified device API described herein. An example OS 111 may include Windows®, Android®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 120 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 120 during execution by the hardware processor 102, EC 104, or GPU 106 of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 120 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 120, the hardware processor 102 (e.g., CPU), the EC 104, the GPU 106, a video/graphic display device 115, or other wired I/O devices 116 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 105 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

FIG. 2 is a block diagram illustrating a hardware processor executing machine readable code instructions for an on the box (OTB) artificial intelligence (AI) productivity tool to utilize dynamically declared natural language descriptions of capabilities of AI productivity tool enableable software applications according to an embodiment of the present disclosure. The OTB AI productivity tool may instruct an AI productivity tool enableable software application to invoke an API call corresponding to a dynamically declared natural language description of a capability that is determined to be in compliance with current hardware configurations or software updates by including dynamically generated vectorized capability intent values for a dynamically changing list of capabilities for comparison to a query input according to an embodiment of the present disclosure. The dynamically declared vectorized capability intent values of the AI productivity tool enableable software application may then be correlated to a vectorized query input intent value for a received user query input according to an embodiment of the present disclosure. As described herein, the OTB AI productivity tool may use an API-agnostic method of directing an AI productivity tool enableable software application to perform a user-requested action with dynamically declared AI productivity tool software application capabilities that are correlated to a user query input. Further, by dynamically tailoring the registered list of capabilities when an AI productivity tool enableable software application is updated to include or remove those capabilities that may be performed in accordance with current hardware component configurations or other software updates, the hardware processor executing machine readable code instructions for the AI productivity tool enableable software application and the OTB AI productivity tool may ensure dynamic updates to a registered capabilities list. In this way, any commands to execute AI productivity tool enableable software application capabilities to alter functionality of a hardware component operating on the information handling system are in accordance with current hardware configuration, policies, and updates to the AI productivity tool enableable software applications.

A manufacturer of edge devices, such as personal or enterprise computers may develop and install on individual edge device information handling systems machine readable code instructions for an OTB AI productivity tool 250 that employs one or more locally executed machine learning models, such as 263, 265, or 267 to optimize user productivity and performance of the information handling system using artificial intelligence methodologies. Examples of an OTB AI productivity tool 250 with artificial intelligence methodologies include chatbots, used with a universal software application conversational interface software application 270, to simulate conversations between the information handling system executing machine readable code instructions of the AI productivity tool enableable software application 211 and the user. The information handling system hardware processor 202 may execute machine readable code instructions of the OTB AI productivity tool 250 to execute one or more capabilities for an application software service, hardware or software operation, response or other function in response to a user query input. For example, a response to a user query via OTB AI productivity tool 250 may trigger processes of one or more AI productivity tool enableable software applications 211 in embodiments herein. A hardware processor 202 executing machine-readable code instructions for various machine learning modules (e.g., 263, 265, and 267) may implement the use of such machine learning models from memory to support such functionality in an embodiment. For example, an automatic speech recognition (ASR) module 263, a text embedding module 265, or a similarity search module 267 that work in various combinations with one another may execute to process audio or text input of a user query and identify a capability of the AI productivity tool enableable software application 211 matching an action requested within user query input received from the universal software application conversational interface software application 270. Further, the hardware processor 202 executing machine-readable code instructions of the intent recognition pipeline machine learning module 261 may orchestrate the interplay between each of the ASR module 263, text embedding module 265, and similarity search module 267 to establish such a query intent vector value in a multi-vector space defined with these machine learning models in an embodiment.

Additionally, changes may occur to the capabilities available on a capabilities list and for the dynamically declared natural language descriptions of capabilities of AI productivity tool enableable software applications when the capabilities are changed, AI productivity tool enableable software applications are updated, hardware configurations and settings are adjusted, or other changes in the information handling system are detected. The hardware processor 202 executing machine-readable code instructions for the various machine learning modules (e.g., 263, 265, and 267) may implement the use of such machine learning models from memory to support functionality of a text embedding module 265 or a similarity search module 267 to work in various combinations with one another to execute to process text input of the capability natural language descriptions of the dynamic list of capabilities for the AI productivity tool 250. The hardware processor 202 executing machine-readable code instructions of the intent recognition pipeline machine learning module 261 may orchestrate the interplay between each of the ASR module 263, text embedding module 265, or similarity search module 267 to establish such a capability intent vector values in a multi-vector space defined with these machine learning models when capabilities are dynamically changed according to embodiments herein.

In an example embodiment, a user may provide a user query input in the form of text or voice data (e.g., via IO device 116, or microphone 118 of FIG. 1) to a universal software application conversational interface software application 270, executing machine readable code instructions as a chatbot with the OTB AI productivity tool 250 to simulate a conversation between the user and the AI productivity tool enableable software application 211. As described herein, such a universal user conversational interface software application 270 may operate separate and apart from the AI productivity tool enableable software application 211 or an interface at the AI productivity tool enableable software application 211 may be used to service requests for actions to be taken by any number of a plurality of AI productivity tool enableable software applications, including 211. The OTB AI productivity tool 250 may operate in part to identify which of the plurality of AI productivity tool enableable software applications, including 211 may be capable of performing the action requested by the user within the user query input. Further, the one or more the AI productivity tool enableable software applications 211 whose dynamically changing list of capabilities that may respond to a user input query may access one or more ML model algorithms on the information handling system that may also be shared by and service other the AI productivity tool enableable software applications 211, the OTB AI productivity tool 250 and its subagent, or other executable software modules. For example, the intent recognition pipeline machine learning module 261, including one or more of the ASR module 263, the text embedding module 265 or similarity search module 267 may be used by execution of code instructions of the query intent determination module 251 to process a query input from a user via the universal software application conversation interface 270 or another interface to determine a query intent values in an embodiment. This same intent recognition pipeline machine learning module 261, including one or more of the ASR module 263, the text embedding module 265 or similarity search module 267 may be used as well by execution of code instructions of the natural language capability intent determination module 253 of the OTB AI productivity tool 250 to receive changes to capabilities and process natural language descriptions of the same for dynamically updating the list of registered capabilities in the capability intent values database 254 in embodiments herein.

The AI productivity tool enableable software application 211 in an embodiment operates with the OTB AI productivity tool 250 for optimizing performance of the information handling system (e.g., directed at optimizing performance of hardware components or other AI productivity tool enableable software applications at the information handling system), or may be one of several AI productivity tool enableable software applications routinely executing on the information handling system, as optimized by received user query input at such an OTB AI productivity tool 250. In each of these scenarios, AI productivity tool enableable software application 211 may have or publish a list of recognized “capabilities” or functionalities that it may perform during execution of such an AI productivity tool enableable software application 211 in response to a query input received and processed by the OTB AI productivity tool 250 into a query intent vector value.

In an embodiment, a capability intent values database 254 may store a dynamically changeable list of a plurality of capabilities associated with each of a plurality of AI productivity tool-enablable AI productivity tool enableable software applications 211. These capabilities stored at the capability intent values database 254 may include any input and output capabilities provided by the AI productivity tool-enablable AI productivity tool enableable software applications 211 being executed by the hardware processor 202 or any other processing devices (104 or 106 of FIG. 1). These capabilities stored at the capability intent values database 254 may include any input and output capabilities provided by the AI productivity tool-enablable software applications 211 being executed by the hardware processor 202 or any other hardware processing devices (104 or 106 of FIG. 1). For example, an AI productivity tool-enablable software application 211 may include a word processing application such as Microsoft® Word® that may receive input (e.g., via voice at a microphone 118 or text via a keyboard 116 of FIG. 1) and provide output via text. Still further, other examples of an AI productivity tool-enablable software application 211 may include an updating software, virus protection software, and setting optimization software such as Dell® SupportAssist® module executable by the hardware processor or other hardware processing resource of the information handling system. With SupportAssist® a user may provide input via, for example, the microphone (118 from FIG. 1) requesting information related to a setting associated with the information handling system. Thus, capabilities of SupportAssist® may include virus protection capabilities, setting manipulation capabilities, and software updating capabilities that may each be stored at the capability intent values database 254.

Even further, examples of an AI productivity tool-enablable software application 211 may include Dell® Display®/Peripheral Manager®. The Dell® Display®/Peripheral Manager® may have capabilities that include optimization of screen resolution, refresh rates, and gamma correction as well as webcam settings, mouse settings, keyboard settings, stylus settings, microphone settings, and trackpad settings, among other settings and connections associated with the wired or wireless input/output devices. Again, these capabilities associated with the execution of the Dell® Display®/Peripheral Manager® software may have capability intent values and a capability identifier stored at the capability intent values database 254 as described herein. It is appreciated that the AI productivity tool-enablable software application 211 may include, for example, Dell® Trusted Device® software, a remediation Dell® APEX Managed Device Service (AMDS)® software, Alienware Command Center (AWCC)® software, among others. Some AI productivity tool-enablable software applications 211 may even be subagents operating locally on the box of the information handling system but have remote access to a larger software application executing at a cloud based server location for providing software services in some embodiments herein.

These “capabilities” may be dynamically registered with the OTB AI productivity tool 250 in an embodiment for establishing capability intent values for these capabilities such that chat user query input intent values may be correlated with one or more capability intent values for registered capabilities, as described herein. For example, in an embodiment in which the AI productivity tool enableable software application 211 is software application for optimizing performance of hardware components at the information handling system, such capabilities may include adjusting settings or configurations for various hardware components. As another example, in an embodiment in which the AI productivity tool enableable software application 211 optimizes performance of other software applications, such capabilities may include automatically downloading and installing updates for such AI productivity tool enableable software applications 211. In yet another example, in an embodiment in which the AI productivity tool enableable software application 211 is one of several software applications routinely executing on the information handling system, and optimized by such an OTB AI productivity tool 250, such capabilities may include automatically generating and transmitting e-mails or text messages, automatically scheduling meetings, or generating chatbot or other user interface responses. These “capabilities” may be registered, associated with a specific AI productivity tool enableable software application 211, and stored with capability name, capability ID, natural language descriptor, capability intent value, or other data at the capability intent values database 254 in an embodiment. The capabilities, as they are changed and updated may be submitted with a natural language description which may be processed to determine a capability intent value dynamically as capabilities are added to the capability intent values database 254 without the code of the OTB AI productivity tool needing to be updated as it will reference the dynamically changing capability intent values database 254 and add capabilities (or remove them) when required.

These input and output capabilities provided by the AI productivity tool-enableable software applications 211 in an embodiment may be triggered for execution by an API call specific to the AI productivity tool-enableable software application 211. Further, these input and output capabilities may be dynamically updated to include new input and output capabilities of the AI productivity tool enableable software application 211, or to remove previously existing input and output capabilities, as the AI productivity tool enable software application 211 undergoes various updates or changes are detected to relevant hardware systems or software on the information handling system. For example, an updated version of an AI productivity tool-enablable software application 211 for updating software, virus protection software, and setting optimization, such as Dell® SupportAssist® module may add a capability to optimize battery charging or test for a newly developed and recognized computer virus, such as “Virus X.”

Any such updates to the input and output capabilities of the AI productivity tool enableable software application would require a corresponding update to a library of API calls for the AI productivity tool enableable software application 211 accessible by the OTB AI productivity tool 250. However, embodiments of the present disclosure circumvent this step of updating API calls by executing machine readable code instructions of the AI productivity tool enableable software application 211 to dynamically adjust the stored database of natural language descriptions for input and output capabilities at the capability intent values database 254 for the AI productivity tool enableable software application 211 by processing the natural language descriptions of the newly added capabilities to a capability intent value that may be linked to the API call of the corresponding AI productivity tool enableable software application 211. Changes made to the capability intent values database 254 made in such a way may not require any update to the OTB AI productivity tool 250 itself. Thus, embodiments of the present disclosure allow for updates being made to the capabilities of the AI productivity tool enableable software application 211, as recognized and invokable by the OTB AI productivity tool 250 that do not require any update to the OTB AI productivity tool 250 itself.

Each of the capabilities stored at the capability intent values database 254, and updated by the AI productivity tool enableable software application 211 may have a description with text descriptors, may be associated with a unique ID, and may have a capability intent value dynamically generated by execution of code instructions of the natural language capability intent determination module 253 in an embodiment. Upon registration or updating of a given capability by the AI productivity tool enableable software application 211 in an embodiment, a hardware processor 202 for the information handling system may execute machine readable code instructions of the natural language capability intent determination module 253 with one or more text embedding algorithms of a text embedding module 265 to generate a multi-dimensional vector capability intent value for that capability that, for example, may be based on text descriptors for that capability. Each of these capability intent values generated by the text embedding module 265 for association with these initial or recently updated capabilities may also be associated with an ID such as an alphanumeric ID that may identify, uniquely, these capabilities in the capability intent values database 254, for example.

In a specific example in which an updated version of an AI productivity tool-enablable software application 211 for updating software, virus protection software, and setting optimization, such as Dell® SupportAssist® module adds a capability, such as to optimize battery charging or test for a newly developed and recognized computer virus, such as “Virus X,” the hardware processor 202 executing machine readable code instructions for the AI productivity tool enableable software application 211 may update the stored capability intent values database 254 to add new natural language descriptions such as “optimize my battery charging,” or “scan for Virus X.” Each of these newly added natural language descriptions of capabilities may then be assigned a capability ID and capability name by the AI productivity tool enableable software application 211. The dynamically generated capability intent values determined by execution of the natural language capability intent determination module 253 may later be used to determine which of the initial or recently updated capabilities a user intends to invoke or execute within a received user query input based on similarity with a query intent value, as described herein.

As described above, the capability intent values for natural language descriptions of initial or updated capabilities for an AI productivity tool enableable software application 211 are a vectorized mathematical representation in a multi-axis vector space of the natural language descriptions of capability operations or services from various AI productivity tool-enablable software applications 211 in an embodiment, as generated using natural language processing (NLP) techniques via execution of machine readable code instructions by the hardware processor 202 of the natural language capability intent determination module 253 and the text embedding module 265. Each axis of the multi-axis vector space may provide a measurement of various attributes of a text excerpt that are known to provide context or semantic understanding of the text. For example, one or more axis values may represent a reader's understanding of a given text excerpt may depend upon the reader's knowledge of any given word's meaning within the text, identified phrases within the text, or the understood order or sequence of words within the text. More specifically, one or more axis values may represent the reader's understanding as enhanced with a larger vocabulary and assigned values for which words in that vocabulary are synonyms (closer in meaning) to a given word in that text, and which words are antonyms (further away in meaning) to that given word. As another example, one or more axis values may represent the reader's ability to identify common phrases, such as “in other words” may provide greater insight to the semantic meaning of a text excerpt using this phrase than an understanding of each of the words “in,” “other,” and “words” used separately from one another would. As yet another example, one or more axis values may represent the importance of the order of certain words in an excerpt may impact semantic meaning of the excerpt. More specifically, the phrase “man bites dog” may have a completely different semantic or contextual meaning than the phrase “dog bites man,” although each phrase has the same words, just in a different order.

Each axis of the multi-axis vector space, and thus, each value within a vector within such a multi-axis vector space may provide a measurement of these various attributes within a given initial or updated capability intent value in embodiments herein. Hundreds of vector axes may be the basis for the intent vector value in a multi-dimensional “space.” For example, a vector for a user query input intent value or for capability intent value may provide a measurement of similarity between any given word within the user query input or AI productivity tool enablable software application capabilities, respectively, a measurement of dissimilarity with known antonyms, identification of any given word as part of a phrase, or usage of any given word in a specific order that is known to be of importance. In such a way, the vectorized user query input intent value and capability intent values may mathematically represent a reader's contextual or semantic understanding of the user query input and the natural language descriptors for the capabilities of the AI productivity tool enableable software applications 211. These vectors may then be compared to one another, via the hardware processor 202 executing machine readable code instructions of the similarity search module 267 to determine statistical correlation, in order to understand how alike various phrases within the user query input and capabilities are, and how alike the usage of those words and phrases are to provide a context, such as influenced by the order of those words or phrases and their relation to one another, as well as other semantic factors represented in the multi-axis vector space.

Several text embedding algorithms may be used in various embodiments herein in order to provide such a mathematical representation of semantic understanding for use with both the natural language capability intent determination module 253 and the query intent determination module 251. For example, the text embedding module 265 may employ a Latent Semantic Analysis (LSA) or Latent Dirichlet allocation (LDA) which may define how observed terms in the received user query input or a capability natural language description are to various synonyms. As another example, the text embedding module 265 may employ a Word2Vec algorithm, which includes a neural network trained to understand which terms or phrases should be considered closer or further away from certain synonyms or antonyms. As yet another example, the text embedding module 265 may employ a fully recurrent neural network trained to consider the order of terms within the received user query input or the natural language descriptors of the capabilities for the AI productivity tool enableable software applications.

As described herein, a hardware processor 202 executing machine readable code instructions for each of the AI productivity tool enableable software applications 211 executing at the information handling system may routinely check current configurations, policies, and statuses of hardware components (e.g., 275) or firmware (e.g., 276) at the information handling system and limit, add, or otherwise adjust the capabilities registered at the OTB AI productivity tool 250 to those invoking actions on the part of the AI productivity tool enableable software application 211 that are in accordance with the current hardware configurations and policies. Such hardware configurations and policies may, in some embodiments, be stored within firmware 276. For example, an AI productivity tool enableable software application 211 that is generally capable of optimizing performance of a removeable battery may have a first list of capabilities that includes “minimize battery usage,” or “optimize battery charging.” During a routine check of current configurations for a power management unit that incorporates the removable battery, a hardware processor 202 executing machine readable code instructions for the AI productivity tool enableable software application 211 that previously registered these existing capabilities may determine that the battery has been removed or been inserted. In such a scenario, the hardware processor 202 executing machine readable code instructions for this AI productivity tool enableable software application 211 may register an updated list of capabilities at the capability intent values database 254 that omits or adds “minimize battery usage,” or “optimize battery charging,” depending on whether the battery has been removed or is installed by the AI productivity tool enableable software application 211.

As another example, an AI productivity tool enableable software application 211 that is generally capable of directing operation of a wireless interface adapter may have a first list of capabilities that includes “use a cellular signal,” or “switch to Wi-Fi.” During a routine check of current configurations for the wireless interface adapter that incorporates a WWAN (e.g., cellular) antenna, the hardware processor 202 executing machine readable code instructions for the AI productivity tool enableable software application 211 that previously registered these existing capabilities may determine that the WWAN antenna is currently offline. In such a scenario, the hardware processor 202 executing machine readable code instructions for this AI productivity tool enableable software application 211 may register an updated list of capabilities at the capability intent values database 254 that omits “use a cellular signal” since the hardware component capable of performing this action is offline. In another embodiment, if a cellular capability comes online or a subscription is initiated, the hardware processor 202 executing machine readable code instructions for this AI productivity tool enableable software application 211 may register an updated list of capabilities at the capability intent values database 254 that adds “use a cellular signal.”

In yet another example, an AI productivity tool enableable software application 211 that is generally capable of directing operation of a digital display may have a first list of capabilities that includes “increase display resolution,” or “to display images in high-definition (HD).” During a routine check of current configurations for the digital display, the hardware processor 202 executing machine readable code instructions for the AI productivity tool enableable software application 211 that previously registered these existing capabilities may determine that the digital display is not capable of HD display resolution. In such a scenario, the hardware processor 202 executing machine readable code instructions for this AI productivity tool enableable software application 211 may register an updated list of capabilities at the capability intent values database 254 that omits “display images in HD,” since the display device is not capable of displaying images in HD. Alternatively, if a display operatively coupled to the information handling system is detected as having higher resolution capabilities such as HD display resolution, the hardware processor 202 executing machine readable code instructions for this AI productivity tool enableable software application 211 may register an updated list of capabilities at the capability intent values database 254 that adds natural language capability descriptions for “display images in HD” or “increase display resolution,” since the display device is now capable of displaying images in HD or other higher resolution.

In still another example, an AI productivity tool enableable software application 211 may have a first list of capabilities, such as “save data to removeable memory device” that include actions that may be barred by administrator-imposed hardware configuration policies. During a routine check of current configurations and policies for a drive unit, the hardware processor 202 executing machine readable code instructions for the AI productivity tool enableable software application 211 that previously registered these existing capabilities may determine that an administrator for the information handling system has restricted storage of data to local and permanent storage in main memory or static memory, and bars storage of data to removeable drive. In such a scenario, the hardware processor 202 executing machine readable code instructions for this AI productivity tool enableable software application 211 may register an updated list of capabilities at the capability intent values database 254 that omits “save data to removeable memory device,” since the current policies do not allow this action. Similarly, such a capability natural language description may be alternatively added if administrator-imposed hardware configuration policies are changed to permit such operations.

As yet another example, an AI productivity tool enableable software application 211 may have a first list of capabilities, such as “connect to network with best received signal strength indicator (RSSI)” that include actions that may be barred by administrator-imposed hardware configuration policies. During a routine check of current configurations and policies for wireless interface adapter, the hardware processor 202 executing machine readable code instructions for the AI productivity tool enableable software application 211 that previously registered this existing capability may determine that an administrator for the information handling system has restricted wireless connectivity to specifically identified secure networks, and bars connectivity to networks that are not in this list or alternatively adds a subscription or additional network connectivity, such as a new cellular connectivity. In such a scenario, the hardware processor 202 executing machine readable code instructions for this AI productivity tool enableable software application 211 may register an updated list of capabilities at the capability intent values database 254 that adds or omits natural language capability descriptions for “connect to network with best RSSI” depending on whether a network with the best RSSI may is on a list of allowable or available secure networks. By tailoring the registered list of capabilities in such a way, a hardware processor 202 executing machine readable code instructions for the AI productivity tool enableable software application and the OTB AI productivity tool may ensure that any commands to alter functionality of a hardware component operating on the information handling system are in accordance with current hardware configuration and policies.

The natural language descriptions of “capabilities” upon updates, software changes, or hardware component changes detected may be registered with the OTB AI productivity tool 250 in an embodiment for dynamically establishing capability intent values for these natural language descriptions for a list of capabilities such that chat user query input intent values determined for received natural language user query inputs may be correlated with one or more dynamically updated capability intent values for registered natural language descriptions of capabilities, as described herein. For example, in an embodiment in which the AI productivity tool enableable software application 211 is an AI productivity tool enableable software application for optimizing performance of hardware components at the information handling system, such natural language descriptions of capabilities may include descriptions for adjusting settings or configurations for various hardware components, such as hardware component 275, via firmware 276. As another example, in an embodiment in which the AI productivity tool enableable software application 211 optimizes performance of other AI productivity tool enableable software applications, such natural language descriptions of capabilities may include descriptions for automatically downloading and installing updates for such AI productivity tool enableable software applications 211 or firmware 276. In yet another example, in an embodiment in which the AI productivity tool enableable software application 211 is one of several AI productivity tool enableable software applications routinely executing on the information handling system, and optimized by such an OTB AI productivity tool 250, such natural language descriptions of capabilities may include descriptions for automatically generating and transmitting e-mails or text messages, automatically scheduling meetings, or generating chatbot or other user interface responses. These natural language descriptions of “capabilities” may be registered, associated with a specific AI productivity tool enableable software application 211, and stored at the capability intent values database 254 in an embodiment. According to embodiments herein, when these capabilities are changed, added to, or removed from availability, the natural language descriptions of “capabilities” may be registered in a capabilities list at the capability intent values database 254 and capability intent values dynamically generated and associated with the API calls and the AI productivity tool-enableable software application 211 relevant to the change or update.

These input and output capabilities provided by the AI productivity tool-enableable software applications 211 in an embodiment may be triggered for execution by an API call specific to the AI productivity tool-enableable software application 211. Further, these input and output capabilities may be updated to include new input and output capabilities of the AI productivity tool enableable software application 211, or to remove previously existing input and output capabilities, as the AI productivity tool enable software application 211 undergoes various updates. For example, an updated version of an AI productivity tool-enablable software application 111 for updating software, virus protection software, and setting optimization, such as Dell® SupportAssist® module may add a capability to optimize battery charging or test for a newly developed and recognized computer virus, such as “Virus X.” In such an embodiment, the hardware processor 202 executing machine readable code instructions for the AI productivity tool enableable software application 211 may update the stored capability intent values database to add new natural language descriptions such as “optimize my battery charging,” or “scan for Virus X.” A capability intent value may be dynamically generated for any new natural language descriptions of the newly added capabilities for example as described in embodiments herein and stored with the capability in the capability intent values database 254. Further, each of these newly added natural language descriptions of capabilities may then be assigned a capability ID and capability name by the AI productivity tool enableable software application 211 and associated with a corresponding API call of the AI productivity tool enableable software application 211.

Each of the natural language descriptions of capabilities stored at the capability intent values database 254 in such a way may be associated with a unique ID and a capability intent value in an embodiment. Upon registration or updating of a given natural language description of capability by the AI productivity tool enableable software application 211 in an embodiment, a hardware processor 202 for the information handling system may execute machine readable code instructions for one or more text embedding algorithms to generate a multi-dimensional vector capability intent value for the natural language description of that capability. Each of these capability intent values for association with these natural language descriptions of capabilities may also be associated with an ID such as an alphanumeric ID that may identify, uniquely, these capabilities in the capability intent values database 254, for example. These capability intent values may later be used to determine which of the capabilities a user intends to invoke or execute within a received user query input, as described herein.

When a user provides a user query input in the form of text or voice data (e.g., via IO device 116, or microphone 118 of FIG. 1) to the universal software application conversational interface software application software application 270, the hardware processor 202 executing machine-readable code instructions of the OTB AI productivity tool 250 in an embodiment may orchestrate determination of the user's intended goals within the user query input (e.g., what the user wishes to achieve with this communication) with a query input intent value, identify one or more capabilities associated with the AI productivity tool enableable software application 211 having a correlating capability intent value and thus, capable of executing this user query input intent, and initiate performance of one or more tasks employing those capabilities to achieve the user-intended results to the user query input. This orchestration in an embodiment may begin with the hardware processor 202 executing machine-readable code instructions of the query intent determination module 251 to receive the user query input via microphone, image, or text input, and initiate execution of machine readable code instructions for an intent recognition pipeline machine learning module 261. In an embodiment, the hardware processor 202 executing machine-readable code instructions for the intent recognition pipeline machine learning module 261 may further orchestrate any combination of a plurality of machine learning modules (e.g., 363, 365, or 367) to determine the user's intended goal or query intent within the received text or voice data of the user query input.

For example, in an embodiment in which the user provides a user query input in the form of voice data to the AI productivity tool enableable software application 211 via the OTB AI productivity tool 250 and the universal software application conversational interface software application 270, the hardware processor 202 executing machine-readable code instructions of the intent recognition pipeline machine learning module 261 may orchestrate consecutive executions, via the hardware processor 202, of machine-readable code instructions of an automated speech recognition (ASR) module 263 to detect words within the recorded voice data. The hardware processor 202 may also execute machine readable code instructions of a text embedding module 265 to detect which of these words are nouns, verbs, or commonly used sentence structures and generate a vectorized query input intent value for the user query input. These vectorized capability intent values and vectorized query input intent values may then be compared to one another, via the hardware processor 202 executing machine readable code instructions of the similarity search module 267, in order to determine a statistical correlation that represents understanding how alike various phrases within the user query input and capabilities are, and how alike the usage of those words and phrases are to provide a context, such as influenced by the order of those words or phrases and their relation to one another. For example, the hardware processor 202 executing machine readable code instructions of the similarity search module 267, and in some embodiments in tandem with algorithms of the text embedding module 265 may compare the vectorized query input intent value with the capability intent values stored within the capability intent value database 254 to identify a capability intent value correlated to the query input intent value, indicating that the user query input is requesting that the AI productivity tool enableable software application 211 execute the capability associated with that capability intent value. Such a comparison, in an embodiment, may include, for example, determining a distance or a vector value difference between the vectorized query input intent value and the vectorized capability intent value or a correlation value between the two. Examples of similarity search module 267 algorithms may include, for example, a Cosine Similarity search machine learning model, a vector space model (VSM) similarity search machine learning model, a K-Means Text Clustering similarity search machine learning model, an Okapi Best Match 25 similarity search machine learning model, a Term Frequency-Inverse Document Frequency (TF-IDF), or a Best Matching 25 (BM25) similarity search machine learning model. These are only a few examples of similarity search algorithms that may be employed and it is contemplated that any known or later-developed similarity search algorithm may also be employed.

In an embodiment in which the user provides text data to the AI productivity tool enableable software application 211, such an intent recognition pipeline machine learning module 261 may truncate this process to exclude processes of the ASR module 263. The hardware processor 202 executing machine-readable code instructions of the intent recognition pipeline machine learning module 261 in an embodiment may then return the output of the similarity search module 267 to the query intent to capability determination module 262. This output in an embodiment may take the form of one or more identified capability intent IDs that specifically identify a capability of the AI productivity tool enableable software application 211 having a vectorized capability intent value that has a highest correlation value or falls within a tolerated maximum vector value distance of the query input intent value, for example.

In a specific example, the detected intent having a query intent value in a multi-vector space, such as “decrease display brightness,” “speed up my application,” or “send a text message” may be associated with a known capability or functionality of AI productivity tool enableable software application 211 at the information handling system. More specifically, the intent “decrease display brightness” may be associated with a capability for adjusting settings or configurations for a display device (115 of FIG. 1), based on similarity correlation between a query intent value and a capability intent value as determined by the similarity search module 267. As another example, the query intent “speed up my application” may be associated with a capability associated with the AI productivity tool enableable software application 211 for automatically downloading and installing updates for such AI productivity tool enableable software application 211, based on similarity correlation between a query intent value and a capability intent value as determined by the similarity search module 267. In yet another example, the query intent “send a text message” may be associated with a capability of the AI productivity tool enableable software application 211 to automatically generate and transmit text messages, based on similarity correlation between a query intent value and a capability intent value as determined by the similarity search module 267. As described above, these “capabilities” may be registered and associated with a specific AI productivity tool enableable software application 211 at the capability intent value database 254 in an embodiment. If the OTB AI productivity tool 250 cannot find a correlation or match between the determined query input intent value and one of the registered capabilities stored at the capability intent value database 254 in an embodiment, the OTB AI productivity tool 250 may transmit an instruction to the universal user conversational interface software application 270 to notify the user, such as through text or automated speech that the requested action cannot be taken.

Upon identification of a capability that addresses the determined query “intent” of the user within the received user query input from the universal software application conversational interface software application 270, the hardware processor 202 executing machine-readable code instructions of the OTB AI productivity tool 250 may direct execution of one or more processes at the AI productivity tool enableable software application 211 associated with that capability. More specifically, the hardware processor 202 executing machine readable code instructions of the OTB AI productivity tool 250 may transmit an instruction to the AI productivity tool enableable software application 211 to perform the pre-registered or updated capability by identifying the capability ID associated with the vectorized capability intent value that best matches the vectorized user query input intent value. In such a way, the OTB AI productivity tool 250 may orchestrate a plurality of machine learning modules via an intent recognition pipeline machine learning module 261 to determine a query intent from a received user query input, and identify a corresponding vectorized capability intent value having threshold similar to the query intent value and execute a capability of the AI productivity tool enableable software application 211 to execute this capability as an operation, software service, response, or other function responsive to the user's query input.

As described herein, existing AI productivity tools may take the further step of identifying an API call needed to instruct the AI productivity tool enableable software application 211 to perform the requested action from the user query input. Thus, any updates to the input and output capabilities of the AI productivity tool enableable software application, such as addition or removal of software application features could require a corresponding update to a library of API calls for the AI productivity tool enableable software application 211 accessible by the OTB AI productivity tool 250. However, embodiments of the present disclosure circumvent this step of updating API calls by executing machine readable code instructions of the AI productivity tool enableable software application 211 to dynamically adjust the stored database of natural language descriptions for input and output capabilities at the capability intent values database 254 for the AI productivity tool enableable software application 211. Changes made to the capability intent values database 254 with dynamically generated capability intent values from the natural language descriptions of capabilities are linked to the API calls of the AI productivity tool-enableable software application 211 and made in such a way may not require any update to the OTB AI productivity tool 250 itself. Thus, embodiments of the present disclosure allow for updates being made to the capabilities of the AI productivity tool enableable software application 211, as recognized and invokable by the OTB AI productivity tool 250 that do not require any update to the OTB AI productivity tool 250 itself.

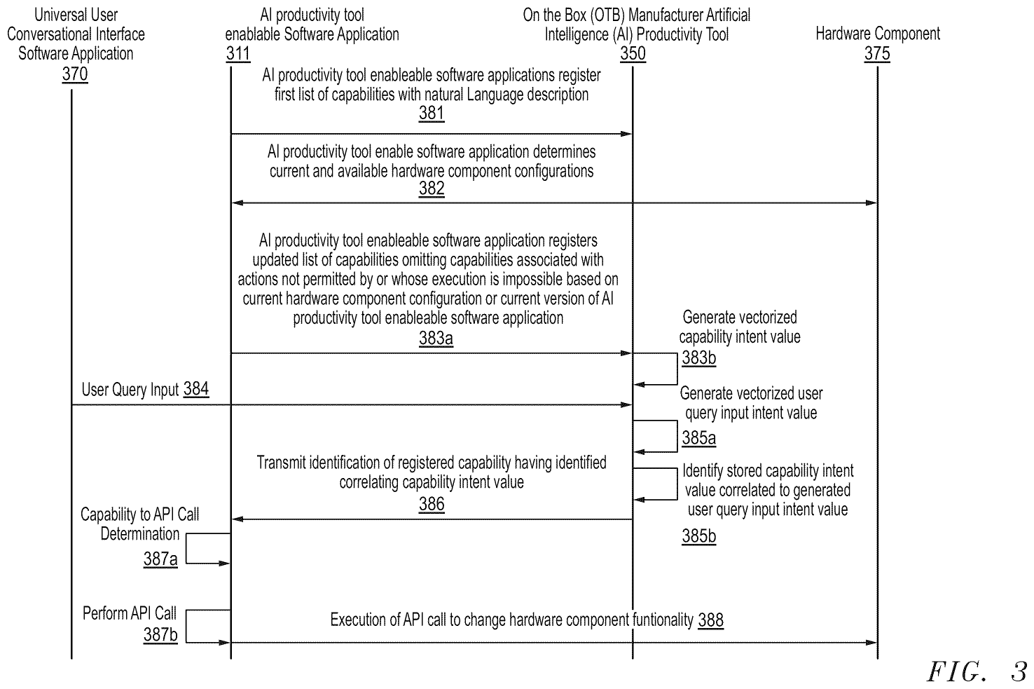

FIG. 3 is a swimlane flow diagram illustrating method of a hardware processor executing machine readable code instructions of an OTB AI productivity tool to instruct an AI productivity tool enableable software application to perform a dynamically registerable capability that is in accordance with current hardware configurations and policies according to an embodiment of the present disclosure. The dynamically registerable capability upon being updated by an AI productivity tool-enableable software application due to updates or changes to software or hardware may have a dynamically generated vectorized capability intent value from an added natural language description of a dynamically added capability. This dynamically generated vectorized capability intent value or other capability intent value in a registered dynamic list of capabilities may then be correlating to a vectorized query input intent value for a received user query input according to an embodiment of the present disclosure.

At 381, a hardware processor executing machine readable code instructions of an AI productivity tool enableable software application 311 may register with the OTB AI productivity tool 350 a first list of capabilities for the AI productivity tool enableable software application 311 with natural language descriptions of those capabilities for that AI productivity tool enableable software application 311. For example, a developer of an AI productivity tool enableable software application 311 for optimizing system performance may register a capability to “minimize battery usage,” or to “optimize battery charging.” This first list of capabilities may include all capabilities that the AI productivity tool enableable software application 311 is capable of performing in general, but may change depending on consideration of whether such an act is in accordance with the local software or hardware component configurations or policies that may be updated or change during operation of the information handling system.

In an embodiment, a capability intent values database at or accessible by the OTB AI productivity tool 350 on the information handling system may store a dynamic plurality of capabilities associated with each of a plurality of AI productivity tool-enablable AI productivity tool enableable software applications 311. These capabilities stored at the capability intent values database at or accessible by the OTB AI productivity tool 350 may include any input and output capabilities provided by the AI productivity tool-enablable AI productivity tool enableable software applications 311 being executed by the hardware processor or any other processing devices (101, 104 or 106 of FIG. 1) and may be updated or change during operation of the information handling system. These capabilities may be provided by AI productivity tool enableable software application 311 with natural language descriptions which have dynamically generated capability intent values and are stored at the capability intent values database at or accessible by the OTB AI productivity tool 350 may include name, natural language description, capability identification value, dynamically generated capability intent value, associated API calls for the capability for any input and output capabilities provided by the AI productivity tool-enablable software applications 311 being executed by the hardware processor or any other hardware processing devices (101, 104 or 106 of FIG. 1).

These “capabilities” are, in such a way, dynamically registered with the OTB AI productivity tool 350 in an embodiment for establishing dynamically generated capability intent values for these capabilities such that chat user query input intent values may be correlated with one or more capability intent values for dynamically updated registered capabilities, as described herein. For example, in an embodiment in which the AI productivity tool enableable software application 311 is software application for optimizing performance of hardware components at the information handling system, such capabilities may include adjusting settings or configurations for various hardware components. As another example, in an embodiment in which the AI productivity tool enableable software application 311 optimizes performance of other software applications, such capabilities may include automatically downloading and installing updates for such AI productivity tool enableable software applications 311. In yet another example, in an embodiment in which the AI productivity tool enableable software application 311 is one of several software applications routinely executing on the information handling system, and optimized by such an OTB AI productivity tool 350, such capabilities may include automatically generating and transmitting e-mails or text messages, automatically scheduling meetings, or generating chatbot or other user interface responses. As described, these “capabilities” may be dynamically registered as associated with a specific AI productivity tool enableable software application 311 and API call for executing that capability, and stored with capability name, capability ID, natural language descriptor, capability intent value, or other data at the capability intent values database at or accessible by the OTB AI productivity tool 350 in an embodiment.

At 382, a hardware processor executing machine readable code instructions of the AI productivity tool enableable software application 311 may determine current and available hardware component configurations and available functionalities of the current version of the AI productivity tool enableable software application 311. A hardware processor executing machine readable code instructions of ach of the AI productivity tool enableable software applications, including 311, executing at the information handling system may routinely check current configurations, policies, and statuses of hardware components, such as hardware component 375 at the information handling system and dynamically tailor the capabilities and natural language descriptions of capabilities registered at the OTB AI productivity tool 350 to those invoking actions on the part of the AI productivity tool enableable software application 311 that are in accordance with the current hardware 375 configurations and policies and supporting existing functionality of the most current version of the AI productivity tool enableable software application 311.

Execution of code instructions for the AI productivity tool enableable software application 311 may include software updates that modify capabilities that are published for that AI productivity tool enableable software application 311 in one embodiment. In other embodiments, the OS, BIOS, hardware drivers and the like may be monitored by a OTB AI productivity tool 350 or subagent for indications of hardware modifications or firmware modifications that occur at the information handling system to determine changes or updates to that hardware or firmware and its effect on one or more capabilities of the AI productivity tool enableable software application 311 in other embodiments. For example, during a routine check of current configurations at 382 for a power management unit 375 that incorporates a removable battery, a hardware processor executing machine readable code instructions of the AI productivity tool enableable software application 311 that registered as part the first capability list stored at the capability intent values database at 381 may determine that the battery has been removed, inserted, or charged. As another example, an updated version of an AI productivity tool-enablable software application 311 for updating software, virus protection software, and setting optimization, such as Dell® SupportAssist® module may add a capability to optimize battery charging or test for a newly developed and recognized computer virus, such as “Virus X.”

Any such updates to the input and output capabilities of the AI productivity tool enableable software application could require a corresponding update to a library of API calls for the AI productivity tool enableable software application 311 at the OTB AI productivity tool 350 accessible by the OTB AI productivity tool 350. However, at 383a embodiments of the present disclosure circumvent this step of updating API calls by executing machine readable code instructions of the AI productivity tool enableable software application 311 to dynamically adjust the stored database of natural language descriptions for input and output capabilities and generate capability intent values at the capability intent values database for dynamically adjusted list of capabilities accessible by the OTB AI productivity tool 350. Changes made to the capability intent values database of the OTB AI productivity tool 350 made in such a way may not require any update to the OTB AI productivity tool 350 itself. With a detected update or change, a capability may be removed in some embodiments from the list of available capabilities and stored in a reserve database in case that capability returns in some embodiments. In other embodiments, a newly added capability may be provided by the AI productivity tool enableable software application 311 with a natural language description and associated at the AI productivity tool enableable software application 311 with an API call for execution of that capability.

At block 383b, the natural language description of the newly added capability is used to dynamically generate a capability intent value for storage in the registered capabilities list with the capability on a capability intent values database. Thus, embodiments of the present disclosure allow for updates being made to the capabilities of the AI productivity tool enableable software application 311, as recognized and invokable by the OTB AI productivity tool 350, that do not require any update to the OTB AI productivity tool 350 itself.

Each of the capabilities dynamically updated and stored at the capability intent values database of the OTB AI productivity tool 350, and updated by the AI productivity tool enableable software application 311 may have a description with text descriptors, may be associated with a unique ID, and may have a capability intent value in an embodiment. Upon registration or updating of a given capability by the AI productivity tool enableable software application 311 in an embodiment, a hardware processor 202 for the information handling system at 383b may execute machine readable code instructions for a natural language capability intent determination module using one or more text embedding algorithms of a text embedding module (265 of FIG. 2) to dynamically generate a multi-dimensional vector capability intent value for that capability that, for example, may be based on text descriptors for that capability. Each of these capability intent values generated by the text embedding module of the OTB AI productivity tool 350 for association with these initial or recently updated capabilities may also be associated with an ID such as an alphanumeric ID that may identify, uniquely, these capabilities in the capability intent values database of the OTB AI productivity tool 350, for example.

In a specific example in which an updated version of an AI productivity tool-enablable software application 311 for updating software, virus protection software, and setting optimization, such as Dell® SupportAssist® module adds a capability to optimize battery charging or test for a newly developed and recognized computer virus, such as “Virus X,” the hardware processor executing machine readable code instructions for the AI productivity tool enableable software application 311 may update the stored capability intent values database for the OTB AI productivity tool 350 to add new natural language descriptions such as “optimize my battery charging,” or “scan for Virus X.” In another example embodiment in which the AI productivity tool enableable software application 311 determines that the battery has been removed or been installed or charged, a hardware processor executing machine readable code instructions of this AI productivity tool enableable software application 311 may register an updated list of capabilities that omits or adds the intents to “minimize battery usage,” or to “optimize battery charging,” for the AI productivity tool enableable software application 311 depending on wither the battery is removed or added. By tailoring the registered list of capabilities in such a way, a hardware processor executing machine readable code instructions of the AI productivity tool enableable software application 311 and the OTB AI productivity tool 350 may ensure that any commands to alter functionality of a hardware component 375 operating on the information handling system are in accordance with current hardware configuration and policies. Each of these newly added natural language descriptions of capabilities may then be assigned a capability ID and capability name by the AI productivity tool enableable software application 311. These capability intent values may later be used to determine which of the initial or recently updated capabilities a user intends to invoke or execute within a user query input received via the universal user conversational interface software application 370 based on similarity with a query intent value, as described herein.

At 384, the hardware processor executing machine readable code instructions of the OTB AI productivity tool 350 in an embodiment at 384 may receive a user query input requesting that an action be taken at the information handling system. At 385a, the hardware processor executes machine readable code instructions of a query intent determination module and use one or more machine-learning methodologies to process an input query and to generate a vectorized user query input intent value for the received user query input. For example, the hardware processor may execute machine readable code instructions of a text embedding module of the OTB AI productivity tool 350 to detect which of the words within the user query input are nouns, verbs, or commonly used sentence structures and generate a vectorized query input intent value for the user query input.

Proceeding to 385b, the hardware processor executing machine readable code instructions of the of the OTB AI productivity tool 350 may compare the vectorized query input intent value with the capability intent values stored within the capability intent value database to identify a capability intent value having a highest or threshold statistical correlation to the query input intent value, indicating that the user query input is requesting that the AI productivity tool enableable software application 311 execute the capability associated with that capability intent value. Such a comparison, in an embodiment, may include, for example, determining a distance or value difference between the vectorized query input intent value and the vectorized capability intent value falls compared to a threshold maximum value or may include determining a correlation value (e.g., statistical similarity up to a 1.00 that is an exact match).

At 386, the hardware processor executing machine-readable code instructions of the of the OTB AI productivity tool 350 in an embodiment may then transmit to the AI productivity tool enableable software application 311 one or more identified capability IDs that specifically identify a capability of the AI productivity tool enableable software application 311 having a vectorized capability intent value that falls within a tolerated maximum distance of the query input intent value, for example.

The AI productivity tool enableable software application 311 in an embodiment at 387a may then identify an API call based on the capability ID, name, or even natural language description to invoke in order to perform the action of the registered capability determined to address the user intent of the user input query identified by the OTB AI productivity tool 350 at 386.

So that each time an AI productivity tool enableable software application 311 is updated, updates to one or more of the above-referenced API calls of the OTB AI productivity tool 350 are not require, the dynamic generation of capability intent values from natural language descriptions of added or new capabilities and a capability ID value are used to disassociate the API calls from the OTB AI productivity tool 350. Thus, each time an AI productivity tool enableable software application is internally updated, the AI productivity tool enableable software application may be required to dynamically re-register natural language description of the capability added and capability ID value to associate them with the list of API calls, but the AI productivity tool-enableable software application 311 may invoke the API calls and there is not a need to perform an update of the OTB AI productivity tool 350. Because the existing AI productivity tools may orchestrate functionality of a plurality of AI productivity tool enableable software applications, this may avoid high-overhead associated with a high frequency of API call updates being registered.

Embodiments of the present disclosure circumvent this step of updating API calls by executing machine readable code instructions of the AI productivity tool enableable software application 311 to dynamically adjust the stored database of natural language descriptions for input and output capabilities and dynamically generate capability intent values for those input and output capabilities when new ones are added at or simply remove ones omitted to a backup database from the capability intent values database of the OTB AI productivity tool 350 for the AI productivity tool enableable software application 311. The capability ID value may be used by the OTB AI productivity tool 350 to identify the capability to be executed, and the AI productivity tool enableable software application 311 may then associate it with an API call for execution of the capability. Thus, changes made to the capability intent values database of the OTB AI productivity tool 350 made in such a way may not require any update to the OTB AI productivity tool 350 itself. Thus, embodiments of the present disclosure allow for updates being made to the capabilities of the AI productivity tool enableable software application 311, as recognized and invokable by the OTB AI productivity tool 350 that do not require any update to the OTB AI productivity tool 350 itself.

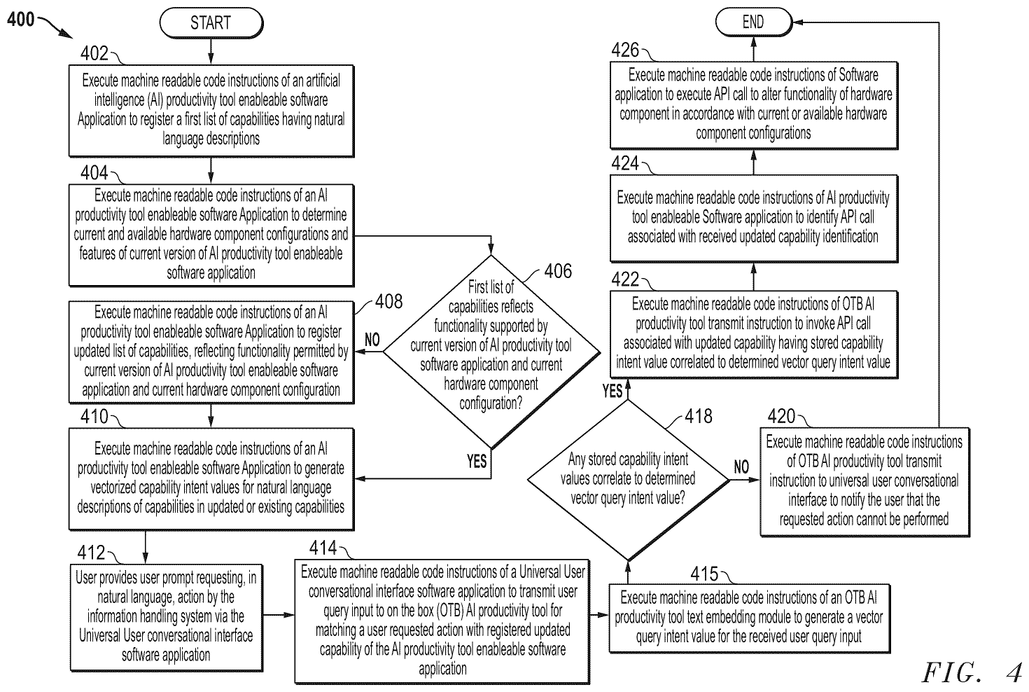

FIG. 4 is a flow diagram illustrating an API-agnostic method of a hardware processor executing machine readable code instructions to instruct updating a pre-registered capability that is in accordance with current hardware configurations and policies by an artificial intelligence (AI) productivity tool enableable software application and executing the updated capability pursuant to a user query input according to an embodiment of the present disclosure. As described herein, an on the box (OTB) AI productivity tool in an embodiment may orchestrate functionality of a plurality of local AI productivity tool enableable software applications having registered capabilities at an information handling system in such a way as to circumvent registration of API calls for the OTB AI productivity tool and instruct performance of those capabilities that are in accordance with current hardware component configurations and policies.

At block 402, a hardware processor executing machine readable code instructions for one or more AI productivity tool enableable software applications at the information handling system in an embodiment may register a first list of capabilities with an on the box (OTB) artificial intelligence (AI) productivity tool described in natural language. For example, in an embodiment described with reference to FIG. 2, above, an AI productivity tool enableable software application 211 may have or publish a list of recognized natural language descriptions of “capabilities” or functionalities that it may perform during execution of such an AI productivity tool enableable software application 211 in response to a query input received and processed by the OTB AI productivity tool 250 into a query intent vector value. In an embodiment, a capability intent values database 254 may store a plurality of natural language descriptions for capabilities associated with each of a plurality of AI productivity tool-enablable AI productivity tool enableable software applications, such as 211. Further, the OTB AI productivity tool 250 may execute an embedding machine learning module to generate capability intent vector values from the natural language descriptions for each of the capabilities registered in the capabilities list at the capability intent values data base 254. These natural language descriptions of capabilities stored at the capability intent values database 254 may describe any input and output capabilities provided by the AI productivity tool-enablable AI productivity tool enableable software applications 211 being executed by the hardware processor 202 or any other processing devices (104 or 106 of FIG. 1).

In another example embodiment described with respect to FIG. 1, an AI productivity tool enableable software application 111 that is generally capable of directing operation of the wireless interface adapter 130 may have a default or first list of capabilities that includes “use a cellular signal,” or “switch to Wi-Fi.” Alternatively, in an embodiment, perhaps Wi-Fi is available but cellular operation is not yet enabled in the first list of capabilities. In yet another example, an AI productivity tool enableable software application 111 that is generally capable of directing operation of the digital display 115 may have a first list of capabilities that includes “increase display resolution,” or “to display images in high-definition (HD).” Alternatively, in an embodiment, perhaps HD resolution not yet enabled in the first list of capabilities where other display device controls are. In still another example, an AI productivity tool enableable software application 111 may have a first list of capabilities, such as “save data to removeable memory device” that include actions that may be barred by administrator-imposed hardware configuration policies. As yet another example, an AI productivity tool enableable software application 111 may have a first list of capabilities, such as “connect to network with best received signal strength indicator (RSSI)” that include actions that may be barred by administrator-imposed hardware configuration policies. Alternatively, in an embodiment, perhaps some wireless network connectivity options are not yet enabled in the first list of capabilities.

The hardware processor executing machine readable code instructions of the AI productivity tool enableable software application in an embodiment at block 404 may determine current and available hardware component configurations for one or more hardware components of the information handling system and functionality for a currently updated version of the AI productivity tool enableable software application. For example, an updated version of an AI productivity tool-enablable software application for updating software, virus protection software, and setting optimization, such as Dell® SupportAssist® module may add a capability to optimize battery charging or test for a newly developed and recognized computer virus, such as “Virus X.” In another example, in an embodiment described with respect to FIG. 1, during a routine check of current configurations for the digital display 115, the hardware processor 102 executing machine readable code instructions of the AI productivity tool enableable software application 111 may determine that the digital display 115 is not capable of HD display resolution or that HD display resolution has been added with the current digital display 115. As another example, during a routine check of current configurations for the wireless interface adapter 130 that incorporates a WWAN (e.g., cellular) antenna 136-1, the hardware processor 102 executing machine readable code instructions of the AI productivity tool enableable software application 111 may determine that the WWAN antenna 136-1 is currently offline or that a new WWAN subscription has been added. As yet another example, during a routine check of current configurations and policies for drive unit 120, the hardware processor 102 executing machine readable code instructions of the AI productivity tool enableable software application 111 may determine that an administrator for the information handling system 100 has restricted storage of data to local and permanent storage in main memory 102 or static memory 103, and bars storage of data to removeable drive 120. In still another example, during a routine check of current configurations and policies for wireless interface adapter 130, the hardware processor 102 executing machine readable code instructions of AI productivity tool enableable software application 111 may determine that an administrator for the information handling system 100 has restricted wireless connectivity to specifically identified secure networks, and bars connectivity to networks that are not in this list or has permitted additional network access.

At block 406, the hardware processor executing machine readable code instructions of the AI productivity tool enableable software application in an embodiment may determine if the first list of capabilities registered at block 402 reflects functionality allowable by the most recently updated version of the AI productivity tool enableable software application and current hardware component configurations. For example, in an embodiment described with respect to FIG. 2, in which an updated version of an AI productivity tool-enablable software application 211 for updating software and virus protection software add a capability to optimize battery charging or test for a newly developed and recognized computer virus, such as “Virus X,” the hardware processor 202 executing machine readable code instructions for the AI productivity tool enableable software application 211 may dynamically update registered list of capabilities at the stored capability intent values database to add new natural language descriptions such as “optimize my battery charging,” or “scan for Virus X” and dynamically generate capability intent values for the same.

As another example, in an embodiment described with respect to FIG. 1, during a routine check of current configurations for the digital display 115, the hardware processor 102 executing machine readable code instructions of the AI productivity tool enableable software application 111 that previously registered capabilities to “increase display resolution,” or “to display images in high-definition (HD)” may determine that the current digital display 115 is not capable of HD display resolution. As an alternative example, during a routine check of current configurations for the digital display 115, the hardware processor 102 executing machine readable code instructions of the AI productivity tool enableable software application 111 may determine that the current digital display 115 is now capable of HD display resolution and that newly added capabilities to “increase display resolution,” or “to display images in high-definition (HD)” may be registered.

As another example, during a routine check of current configurations for the wireless interface adapter 130 that incorporates a WWAN (e.g., cellular) antenna 136-1, the hardware processor 102 executing machine readable code instructions of the AI productivity tool enableable software application 111 may determine that the WWAN antenna 136-1 is currently offline and that the previously registered first set of capabilities including “use a cellular signal” or “switch to Wi-Fi” from cellular are unavailable. As an alternative example, during a routine check of current configurations for the wireless interface adapter 130 that incorporates a WWAN (e.g., cellular) antenna 136-1, the hardware processor 102 executing machine readable code instructions of the AI productivity tool enableable software application 111 may determine that an update has included a new subscription available for a cellular connectivity in addition to a previous Wi-Fi connection and that a new set of capabilities including “use a cellular signal” or “switch to Wi-Fi” are now registrable with the OTB AI productivity tool 150.

As yet another example, during a routine check of current configurations and policies for drive unit 120, the hardware processor 102 executing machine readable code instructions of the AI productivity tool enableable software application 111 that previously registered a capability to “save data to removeable memory device” may determine that an administrator for the information handling system 100 has restricted storage of data to local and permanent storage in main memory 102 or static memory 103, and bars storage of data to removeable drive 120.

In still another example, during a routine check of current configurations and policies for wireless interface adapter 130, the hardware processor 102 executing machine readable code instructions of the AI productivity tool enableable software application 111 that previously registered a capability to “connect to network with best received signal strength indicator (RSSI)” may determine that an administrator for the information handling system 100 has restricted wireless connectivity to specifically identified secure networks, and bars connectivity to networks that are not in this list or has now added as subscription or access to a new wireless network as described above. As such, the capability “connect to network with best received signal strength indicator (RSSI)” may or may not be now registrable with the capability intend database 154 in embodiments herein depending on the current updated status of the wireless connections available and permitted.

If the current hardware component configurations bar execution of the capability within the first registered capabilities list above from block 402, or make such an action impossible, or if the first registered capabilities list of natural language descriptions of capabilities does not include all functionality newly added or removed by a recent update to the AI productivity tool enableable software application, the method may proceed to block 408. At block 408, the plurality of AI productivity tool enableable software applications may dynamically re-register newly added capabilities or remove capabilities to a dynamically updated list of natural language descriptions for capabilities that does not include the capability whose execution has been barred or made impossible or reflects current functionality of the AI productivity tool enableable software application added during updates of hardware, software, or firmware. Such status of software updates or available hardware or firmware modifications at the information handling system may be gathered by AI productivity tool enableable software applications or managed and orchestrated by the AI productivity tool and the AI productivity tool enableable software applications notified of the changes. The software updates or available hardware or firmware modifications may be gathered from records of such updates stored in BIOS, OS, from hardware drivers, or from AI productivity tool enableable software applications themselves in embodiments herein.

If the current hardware component configurations do bar execution of a capability within the first list, or if the first registered capability list does not include all functionality newly added or removed by a recent update to the AI productivity tool enableable software application, hardware or firmware, the method may proceed to block 408 for dynamic registration of changes for natural language descriptions of capabilities in the registered capabilities list. If the current hardware component configurations do not bar execution of the capability within the first registered capabilities list, and if the first capability list includes all current functionality of the AI productivity tool enableable software application or hardware, software and firmware on the information handling system, the method may proceed to block 410 for dynamic determination of a capability intent value for each of the existing or any updated natural language descriptions for the capabilities of the AI productivity tool enableable software application as described in embodiments herein.

At block 408, in an embodiment in which the current hardware component configurations bar the capability within the first list, or in which the first list of natural language descriptions of capabilities does not include all functionality newly added or removed by a recent update to the AI productivity tool enableable software application, the hardware processor executing machine readable code instructions of the AI productivity tool enableable software application may register dynamically update the list of registered capabilities with a new natural language description of an added capability or an instruction to remove a newly barred or omitted capability. This dynamic update to the list of registered capabilities will reflect functionality permitted by current version of AI productivity tool enableable software application and current hardware component configuration detected at the information handling system without needing to update the machine readable code instructions of the OTB AI productivity tool as well.

For example, in an embodiment described with respect to FIG. 2 in which an updated version of an AI productivity tool-enablable software application 211 for updating software, virus protection software, and setting optimization, such as Dell® SupportAssist® module adds a capability to optimize battery charging or test for a newly developed and recognized computer virus, such as “Virus X,” the hardware processor 202 executing machine readable code instructions for the AI productivity tool enableable software application 211 may update the stored capability intent values database 254 to add new natural language descriptions such as “optimize my battery charging,” or “scan for Virus X.”

In another example embodiment described with respect to FIG. 1, in which the hardware processor 102 executing machine readable code instructions of the AI productivity tool enableable software application 111 determines that the digital display 115 is not capable of HD display resolution, the hardware processor 102 executing machine readable code instructions of the AI productivity tool enableable software application 111 may register an updated list of capabilities that omits the capability to “display images in HD,” since the display device 115 is not capable of displaying images in HD. In such an embodiment, the capabilities omitted and their natural language descriptions, as well as any capability name, identification value, associate AI productivity tool enableable software application, or other data, may be stored in a backup data storage location such as solid state drive memory in the event of later reactivation. In an alternative embodiment, in which the hardware processor 102 executing machine readable code instructions of the AI productivity tool enableable software application 111 determines that the digital display 115 is newly capable of HD display resolution, the hardware processor 102 executing machine readable code instructions of the AI productivity tool enableable software application 111 may register an updated list of capabilities that adds the capability to “display images in HD” or “increase display resolution” since the display device 115 is now capable of displaying images in HD or a higher resolution.

As another example, in an embodiment in which the hardware processor 102 executing machine readable code instructions of the AI productivity tool enableable software application 111 determines that the WWAN antenna 136-1 is currently offline, the hardware processor 102 executing machine readable code instructions of the AI productivity tool enableable software application 111 may register an updated list of capabilities that omits the capability to “use a cellular signal” since the hardware component 136-1 capable of performing this action is offline. In such an embodiment, the capabilities omitted and their natural language descriptions, as well as any capability name, identification value, associate AI productivity tool enableable software application, or other data, may be stored in a backup data storage location such as solid state drive memory in the event of later reactivation. In an alternative embodiment, in which the hardware processor 102 executing machine readable code instructions of the AI productivity tool enableable software application 111 determines that a new subscription for cellular connectivity has been activated and that the WWAN antenna 136-1 is currently operable, the hardware processor 102 executing machine readable code instructions of the AI productivity tool enableable software application 111 may register an updated list of capabilities that adds the capability to “use a cellular signal” or “switch to Wi-Fi” or “switch to cellular” since the hardware component 136-1 capable of performing this action between now available wireless network connectivity.

As yet another example, in an embodiment in which the hardware processor 102 executing machine readable code instructions of the AI productivity tool enableable software application 111 determines that an administrator for the information handling system 100 has restricted storage of data to local and permanent storage in main memory 102 or static memory 103, and bars storage of data to removeable drive 120, the hardware processor 102 executing machine readable code instructions of the AI productivity tool enableable software application 111 may register an updated list of capabilities that omits the capability to “save data to removeable memory device,” since the current policies do not allow this action.

In still another example, in an embodiment in which the hardware processor 102 executing machine readable code instructions of the AI productivity tool enableable software application 111 determines that an administrator for the information handling system 100 has restricted wireless connectivity to specifically identified secure networks, and bars connectivity to networks that are not in this list, the hardware processor 102 executing machine readable code instructions of the AI productivity tool enableable software application 111 may register an updated list of capabilities that omits the capability to “connect to network with best RSSI,” since the network with the best RSSI may not be on the list of allowable, secure networks. In such an embodiment, the capabilities omitted and their natural language descriptions, as well as any capability name, identification value, associate AI productivity tool enableable software application, or other data, may be stored in a backup data storage location such as a solid state drive memory in the event of later reactivation. In an alternative embodiment, in which the hardware processor 102 executing machine readable code instructions of the AI productivity tool enableable software application 111 determines that a new subscription for wireless connectivity has been activated or authorized as secure and is currently operable, the hardware processor 102 executing machine readable code instructions of the AI productivity tool enableable software application 111 may register an updated list of capabilities that dynamically adds the capability “connect to network with best RSSI” in natural language.

By dynamically tailoring the registered list of capabilities in such a way, the hardware processor 102 executing machine readable code instructions of the AI productivity tool enableable software application 111 and the OTB AI productivity tool 150 may ensure that any commands to alter functionality of a hardware component operating on the information handling system 100 are in accordance with current hardware configuration and policies.

Each of the natural language descriptions of capabilities within the first list registered at block 402 or newly added natural language descriptions of capabilities updated at block 408 may then be assigned a capability ID and capability name by the AI productivity tool enableable software application. These natural language descriptions of capabilities may later be used to determine which of the initial or recently updated capabilities a user intends to invoke or execute within a received user query input based on similarity with a query intent value, as described herein. The method may then proceed to block 410 for dynamic determination of a capability intent value for each of the existing or updated natural language descriptions for the capabilities of the AI productivity tool enableable software application.

At block 410, a hardware processor may execute machine readable code instructions of the AI productivity tool enableable software application in an embodiment to dynamically generate vectorized capability intent values for natural language descriptions of capabilities in the updated capabilities or maintain existing capabilities in a registered list of capabilities at the capability intent values database. For example, in an embodiment described with reference to FIG. 2, each of the capabilities stored at the capability intent values database 254, including any that are updated by the AI productivity tool enableable software application 211, may have a description with text descriptors, may be associated with a unique ID, and may have a capability intent value generated based on those text descriptors in an embodiment. Upon registration or updating of a given capability by the AI productivity tool enableable software application 211 in an embodiment at blocks 402 or 408, respectively, a hardware processor 202 for the information handling system may execute machine readable code instructions of a natural language capability intent module 253 utilizing one or more text embedding algorithms of a text embedding module 265 to generate a multi-dimensional vector capability intent value for that capability that, for example, is based on text descriptors for that capability.

Each of these capability intent values generated by the text embedding module 265 for association with these initial or recently updated capabilities may also be associated with a capability identification value or capability ID such as an alphanumeric ID that may identify, uniquely, each of these capabilities in the capability intent values database 254, for example. In a specific example in which an updated version of an AI productivity tool-enablable software application 211 for updating software, virus protection software, and setting optimization, such as Dell® SupportAssist® module adds a capability to optimize battery charging or test for a newly developed and recognized computer virus, such as “Virus X,” the hardware processor 202 executing machine readable code instructions for the AI productivity tool enableable software application 211 may update the stored capability intent values database 254 to add new natural language descriptions such as “optimize my battery charging,” or “scan for Virus X.” Each of these newly added natural language descriptions of capabilities may then be assigned a capability ID and capability name by the AI productivity tool enableable software application 211 and that and other data for the capability stored in an updated capabilities list at the capability intent values database 254. These capability intent values may later be used to determine which of the initial or recently updated capabilities a user intends to invoke or execute within a received user query input based on similarity with a query intent value, as described herein.

As described above, the capability intent values for natural language descriptions of initial or updated capabilities for an AI productivity tool enableable software application 211 are a vectorized mathematical representation in a multi-axis vector space of the natural language descriptions of capability operations or services from various AI productivity tool-enablable software applications 211 in an embodiment. These capability intent values are generated using natural language processing (NLP) techniques via execution of machine readable code instructions by the hardware processor 202 of the natural language capability intent determination module 253 utilizing at least one text embedding module 265. Each axis of the multi-axis vector space may provide a measurement of various attributes of a text excerpt that are known to provide context or semantic understanding of the text. For example, one or more axes of the capability intent value may represent a reader's understanding of a given text excerpt may depend upon the reader's knowledge of any given word's meaning within the text, identified phrases within the text, or the understood order or sequence of words within the text. More specifically, one or more axes of the capability intent value may represent the reader's understanding enhanced with a larger vocabulary and correlation value of which words in that vocabulary are synonyms (closer in meaning) to a given word in that text, and which words are antonyms (further away in meaning) to that given word. As another example, one or more axes of the capability intent value may represent the reader's ability to identify common phrases, such as “in other words” may provide greater insight to the semantic meaning of a text excerpt using this phrase than the reader's understanding of each of the words “in,” “other,” and “words” used separately from one another. As yet another example, one or more axes of the capability intent value may represent the importance of the order of certain words in an excerpt may impact semantic meaning of the excerpt. More specifically, the phrase “man bites dog” may have a completely different semantic or contextual meaning than the phrase “dog bites man,” although each phrase has the same words, just in a different order.

Each axis of the multi-axis vector space, and thus, each value within a vector within such a multi-axis vector space may provide a measurement of these various attributes within a given initial or updated capability intent value in embodiments herein. For example, a vector for a user query input intent value or for capability intent value may provide a measurement of similarity between any given word within the user query input or AI productivity tool enablable software application capabilities, respectively, a measurement of dissimilarity with known antonyms, identification of any given word as part of a phrase, or usage of any given word in a specific order that is known to be of importance. In such a way, the vectorized user query input intent value and capability intent values may mathematically represent a reader's contextual or semantic understanding of the user query input and the natural language descriptors for the capabilities of the AI productivity tool enableable software applications 211. These vectors may then be compared to one another, via the hardware processor 202 executing machine readable code instructions of the similarity search module 267, in order to understand how alike various phrases within the user query input and capabilities are, and how alike the usage of those words and phrases are to provide a context, such as influenced by the order of those words or phrases and their relation to one another. For example, comparison between vector values may be used to determine correlation between vectors such as correlation between a query intent vector and a capability intent vector as described in embodiments below.

After the hardware processor executing machine readable code instructions of the AI productivity tool enableable software application has registered the first or an updated list of capabilities at block 402 or block 408, respectively, and vectorized capability intent values have been dynamically generated for those capabilities as determined at block 410, a user may provide a user query input in an embodiment at block 412 requesting in natural language, via a universal user conversational interface software application, an action by the information handling system. For example, a user may provide text or voice data (e.g., via IO device 116, or microphone 118 of FIG. 1) to a universal user conversational interface software application 270, operating as a chatbot to simulate a conversation between the user and any of several AI productivity tool enableable software applications, including the AI productivity tool enableable software application 211 as described with FIG. 2.

At block 414, the hardware processor executing machine readable code instructions of a universal user conversational interface software application in an embodiment may transmit the received user query input to the OTB AI productivity tool. For example as described in FIG. 2, once the capabilities have been registered with the OTB AI productivity tool 250 at block 402 or 408, at the registered capability intent value database 254, the hardware processor 202 executing machine readable code instructions of the OTB AI productivity tool 250 in an embodiment may receive a user query input requesting that an action be taken at the information handling system, and may use machine-learning methodologies to determine a capability for an AI productivity tool enableable software application 211, that can address the request in the user query input. In example embodiments, the OTB AI productivity tool 250 may receive a user query input to “make my system faster” “make my image clearer” or to “extend battery life.”

The hardware processor executing machine readable code instructions of the OTB AI productivity tool in an embodiment at block 416 may generate a vector query intent value for the received user query input. For example, as described with reference to FIG. 2, in an embodiment in which the user provides a user query input in the form of voice data to the AI productivity tool enableable software application 211 via the OTB AI productivity tool 250 and the universal software application conversational interface software application 270, the hardware processor 202 executing machine-readable code instructions of an automated speech recognition (ASR) module 263 to detect words within the recorded voice data. The hardware processor 202 may also execute machine readable code instructions of a text embedding module 265 to detect which of these words are nouns, verbs, or commonly used sentence structures or other features and generate a vectorized query input intent value for the user query input, using similar methodology to that used to generate the capability intent values based on the natural language descriptions for the various current or updated capabilities.

At block 418, it may be determined whether any stored capability intent values correlate to determined vector query intent values. For example, as described with reference to FIG. 2, the hardware processor 202 executing machine readable code instructions of the similarity search module 267 may compare the vectorized query input intent value with the capability intent values stored within the capability intent value database 254 to identify a capability intent value correlated to the query input intent value, indicating that the user query input is requesting that the AI productivity tool enableable software application 211 execute the capability associated with that capability intent value. Such a comparison, in an embodiment, may include, for example, determining a distance or vector value differences between the vectorized query input intent value and the vectorized capability intent value falls below a threshold maximum value or a statistical correlation (e.g., out of a correlation of 1 indicating exact match correlation) may be determined between the vectorized query input intent value and the vectorized capability intent value.

As a specific example, the hardware processor executing machine readable code instructions of the OTB AI productivity tool in an embodiment may determine at block 418 that the capability to “decrease CPU usage” registered as described above has a capability intent value that correlates within a threshold level to a query input intent value for the natural language user query input to “decrease usage of the CPU by background applications.” As another example, the hardware processor executing machine readable code instructions of the OTB AI productivity tool in an embodiment may determine that a query input intent value for the user query input request to “extend battery life” does not correlate within a threshold level to any capability intent values determined for the current list of registered capabilities, as registered in an updated list. This may be the case because the AI productivity tool enableable software application 111 determined that the removeable battery had been removed from the system, and consequently omitted the capability to “decrease battery usage,” or to “maximize battery charging” from the updated list of registered capabilities.

If the hardware processor executing machine readable code instructions of the OTB AI productivity tool does correlate the vectorized user query input intent value determined from the user query input with a capability intent value for a natural language description of an existing or updated capability within the most recently registered list of capabilities, this indicates that the AI productivity tool enableable software application that registered the matching capability is capable of performing the action requested within the user query input at block 418. The method may then proceed to block 422 for performance of the requested capability. If the hardware processor executing machine readable code instructions of the OTB AI productivity tool does not sufficiently correlate within a threshold the user query input intent value determined from the user query input with a capability intent value for a natural language description of an existing or updated capability within the most recently registered list of capabilities, this indicates that none of the AI productivity tool enableable software applications that registered lists of capabilities are capable of performing the action requested within the user query input at block 418. The method may then proceed to block 420 to inform the user that the requested action cannot be performed.

In an embodiment in which the hardware processor executing machine readable code instructions of the OTB AI productivity tool does not correlate the vectorized query input intent value determined from the user query input with any capability intent value for a registered capability within the most recently registered list of capabilities, the hardware processor executing machine readable code instructions of the OTB AI productivity tool at block 420 may transmit an instruction to the universal user conversational interface software application to notify the user that the requested action cannot be performed. For example, with reference to FIG. 2, if the hardware processor 202 executing machine readable code instructions of the OTB AI productivity tool 250 cannot find a correlating match between the determined query input intent value and a capability intent value for one of the registered capabilities stored at the capability intent value database 254 in an embodiment, the OTB AI productivity tool 250 may transmit an instruction to the universal user conversational interface software application 270 to notify the user, such as through text or automated speech that the requested action cannot be taken. More specifically, in an embodiment in which the hardware processor executing machine readable code instructions of the OTB AI productivity tool determines that the query input intent value for the received user query input to “extend battery life” does not match any capability intent values for current lists of registered capabilities, as registered in an updated list, the hardware processor executing machine readable code instructions of the OTB AI productivity tool 250 may transmit an instruction to the universal user conversational interface software application 270 to notify the user that the request to “extend battery life” cannot be performed.

At block 422, in an embodiment in which the hardware processor executing machine readable code instructions of the OTB AI productivity tool can correlate the query input intent value for a natural language user query input with a capability intent value for a natural language description of an existing or updated capability within the most recently registered list of capabilities, the hardware processor executing machine readable code instructions of the OTB AI productivity tool may transmit an instruction to perform the action associated with the identified registered capability to one of a plurality of AI productivity tool enableable software applications executing at the information handling system that registered the identified capability. For example, in an embodiment in which the hardware processor executing machine readable code instructions of the OTB AI productivity tool determines that the capability intent value determined for a capability to “decrease CPU usage” registered at block 402 by a specific AI productivity tool enableable software application matches a query input intent value for a natural language user query input to “decrease usage of the CPU by background applications,” as determined by the intent determination module, the hardware processor executing machine readable code instructions of the OTB AI productivity tool may transmit an instruction to invoke an API call at the AI productivity tool enableable software application for performing the matching capability and which may be identified to the AI productivity tool enableable software application using the capability ID associated with the matching capability from the capabilities intent values database

The hardware processor executing machine readable code instructions of the AI productivity tool enableable software application in receipt of the instruction from the OTB AI productivity tool to perform the matching capability in an embodiment at block 424 may associate the received capability identified by OTB AI productivity tool with an application programming interface (API) call to execute an action requested within the user query input. As described herein, existing AI productivity tools may take the further step utilizing the API call identified by the AI productivity tool enableable software application needed to perform the requested action from the user query input by the AI productivity tool enableable software application, such as when invoking a needed machine learning model algorithm used by the AI productivity tool enableable software application. Thus, any updates to the input and output capabilities of the AI productivity tool enableable software application, such as addition or removal of software application features could require a corresponding update to a library of API calls for the AI productivity tool enableable software application accessible in the code instructions of the OTB AI productivity tool.

However, embodiments of the present disclosure circumvent this step of updating API calls by executing machine readable code instructions of the AI productivity tool enableable software application to dynamically adjust the stored database of natural language descriptions for input and output capabilities and dynamically generating capability intent values from those updated natural language descriptions in a registered capabilities list at the capability intent values database. Further, the updated natural language descriptions for a newly added capability in the registered capabilities list at the capability intent values database associated with a capability identification value for the capability of the AI productivity tool enableable software application at the capability intent values database. Changes made to the capability intent values database made in such a way may not require any update to the OTB AI productivity tool itself. The capability identification value may be used to notify the AI productivity tool enableable software application of the API call associated with the updated capability and included as part of the update. Thus, embodiments of the present disclosure allow for updates being made to the capabilities of the AI productivity tool enableable software application, as recognized and invokable by the OTB AI productivity tool, which do not require any update to the OTB AI productivity tool itself.

At block 426, the hardware processor executing machine readable code instructions for the AI productivity tool enableable software application in an embodiment may execute the identified API call to alter functionality of a hardware component in accordance with current or available hardware component configurations. This may include invoking one or more AI model algorithms via the AI productivity tool that are commonly available to AI productivity tool enableable software applications on an information handling system. The API-agnostic method of instructing execution of actions by an AI productivity tool enableable software application, requested in natural language within a user query input may then end.

The blocks of the flow diagram of FIG. 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system operating an On the Box (OTB) Artificial Intelligence (AI) productivity tool comprising:
a hardware processor to receive an update for an AI productivity tool enableable software application with an updated capability having a natural language description;
the hardware processor to execute machine readable code instructions to generate a vectorized capability intent value from the natural language description of the updated capability;
the hardware processor to execute machine readable code instructions of an AI productivity tool enableable software application to dynamically register with the OTB AI productivity tool the vectorized capability intent value of the natural language description for the updated capability of the AI productivity tool enableable software application;
the hardware processor to execute machine readable code instructions of the OTB AI productivity tool to receive, via a universal user conversational interface software application, a user query input requesting performance of an action;
the hardware processor to execute machine readable code instructions of the OTB AI productivity tool to determine that the vectorized query input intent value for the user query input correlates to the vectorized capability intent value determined for the registered natural language description of the updated capability, indicating that the user query input requests performance of the natural language capability; and
the hardware processor to execute machine readable code instructions for the OTB AI productivity tool to instruct the AI productivity tool enableable software application to perform the registered capability.

2. The information handling system of claim 1 further comprising:
the hardware processor to execute code instructions of the AI productivity tool enableable software application to execute an application programming interface (API) call for performing the natural language capability requested within the user query input, wherein the API call causes an adjustment in operation of a hardware component of the information handling system.

3. The information handling system of claim 1, wherein the natural language description of the updated capability omits a previous feature that has been removed or disabled in a most recent update to the AI productivity tool enableable software application.

4. The information handling system of claim 1, wherein the natural language description of the updated capability includes a new functionality for a hardware component of the information handling system that has been added in a most recent update to firmware for the hardware component.

5. The information handling system of claim 1, wherein the natural language description of the updated capability omits a previous functionality for a hardware component of the information handling system that has been removed or disable in a most recent update to firmware for the hardware component.

6. The information handling system of claim 1 further comprising:
the hardware processor to execute code instructions of the AI productivity tool enableable software application to execute an application programming interface (API) call for performing the updated capability requested within the user query input, wherein the API call causes an adjustment in operation of a hardware component of the information handling system.

7. The information handling system of claim 1 further comprising:
the hardware processor to execute machine readable code instructions of the OTB AI productivity tool to determine the vectorized query input intent value for the user query input and the vectorized capability intent value determined for the natural language description of the updated capability using a natural language processing (NLP) text embedding algorithm.

8. An application programming interface (API)-agnostic method of instructing execution of updated capabilities by an artificial intelligence (AI) productivity tool enableable software application from a user query input at an information handling system comprising:
registering with the OTB AI productivity tool, via a hardware processor executing machine readable code instructions of an AI productivity tool enableable software application, an update for an AI productivity tool enableable software application with an updated capability having a natural language description;
generating, via the hardware processor executing machine readable code instructions of the OTB AI productivity tool, a vectorized capability intent value from the natural language description of the updated capability of the AI productivity tool enableable software application;
receiving at the OTB AI productivity tool, via a hardware processor executing machine readable code instructions of a universal user conversational interface software application, a user query input requesting performance of an action;
determining, via the hardware processor executing machine readable code instructions of the OTB AI productivity tool, that a vectorized query input intent value for the user query input correlates to the vectorized capability intent value determined for the registered natural language description of the updated capability indicating that the user query input is requesting performance of the updated capability; and
instructing, via the hardware processor executing machine readable code instructions of the OTB AI productivity tool, the AI productivity tool enableable software application to perform the updated capability.

9. The method of claim 8, wherein the vectorized capability intent value is a vectorized mathematical representation in a multi-axis vector space of the natural language description of the updated capability describing operations or services from the updated AI productivity tool enableable software application, where the vectorized capability intent value is generated via execution of machine readable code instructions by the hardware processor of a text embedding algorithm.

10. The method of claim 8, wherein the vectorized capability intent value is a vectorized mathematical representation in a multi-axis vector space of the natural language description of the updated capability with a first axis of the multi-axis vector space measuring likelihood that a plurality of words within the natural language description of the updated capability form a known phrase.

11. The method of claim 8 further comprising:
the hardware processor to execute code instructions of the AI productivity tool enableable software application to execute an application programming interface (API) call for performing the updated capability requested within the user query input, wherein the API call causes an adjustment in operation of a hardware component of the information handling system.

12. The method of claim 8, wherein the natural language description of the updated capability includes a new feature that has been added in a most recent update to the AI productivity tool enableable software application.

13. The method of claim 8, wherein the natural language description of the updated capability includes removes a feature and a capability with a most recent update to the AI productivity tool enableable software application.

14. The method of claim 8, wherein the natural language description of the updated capability includes an adjusted functionality for a hardware component of the information handling system that has been adjusted in a most recent update to firmware for the hardware component.

15. An information handling system operating an On the Box (OTB) Artificial Intelligence (AI) productivity tool comprising:
a hardware processor to execute machine readable code instructions of an AI productivity tool enableable software application to determine an update to the AI productivity tool enableable software application has adjusted at least one capability of the AI productivity tool enableable software application;
a hardware processor to execute machine readable code instructions of an AI productivity tool enableable software application to automatically register with the OTB AI productivity tool an update for an AI productivity tool enableable software application with an updated capability with a natural language description for the updated capability;
the hardware processor to execute machine readable code instructions of the OTB AI productivity tool to generate a vectorized capability intent value from the natural language description of the updated capability of the AI productivity tool enableable software application;
the hardware processor to execute machine readable code instructions of the OTB AI productivity tool to receive, via a universal user conversational interface software application, a user query input requesting performance of an action;
the hardware processor to execute machine readable code instructions of the OTB AI productivity tool to determine that a vectorized query input intent value for the user query input correlates to the vectorized capability intent value determined for the registered natural language description of the updated capability indicating that the user query input is requesting performance of the updated capability; and
the hardware processor to execute machine readable code instructions for the OTB AI productivity tool to instruct the AI productivity tool enableable software application to execute the updated capability.

16. The information handling system of claim 15, wherein the natural language description of the updated capability includes a new functionality for a hardware component of the information handling system that has been allowed in a most recent update to hardware component policies.

17. The information handling system of claim 15, wherein the natural language description of the updated capability omits a previous functionality for a hardware component of the information handling system that has been disallowed in a most recent update to hardware component policies.

18. The information handling system of claim 15, wherein the natural language description of the updated capability includes a new feature that has been added in a most recent update to the AI productivity tool enableable software application.

19. The information handling system of claim 15, wherein the natural language description of the updated capability omits a previous feature that has been removed or disabled in a most recent update to the AI productivity tool enableable software application.

20. The information handling system of claim 15, wherein the natural language description of the updated capability includes an adjusted functionality for a hardware component of the information handling system that has been adjusted in a most recent update to firmware for the hardware component.
